(19) United States
(12) Patent Application Publication
(10) Pub. No.: US 2024/0405592 A1
(43) Pub. Date: Dec. 5, 2024

(54) SYSTEMS, METHODS, AND DEVICES FOR PULSE AMPLITUDE MODULATED CHARGING

(71) Applicant: MILWAUKEE ELECTRIC TOOL CORPORATION, Brookfield, WI (US)

(72) Inventor: Mahesh M. Swamy, Gurnee, IL (US)

(21) Appl. No.: 18/700,429

(22) PCT Filed: Oct. 21, 2022
(86) PCT No.: PCT/US2022/047375

§ 371 Date: Apr. 11, 2024

Related U.S. Application Data
(60) Provisional application No. 63/270,601, filed on Oct. 22, 2021.

(51) Int. Cl. H02J 7/06; H02J 7/00; H02M 1/42; H02M 3/00; H02M 3/335

(52) U.S. Cl. CPC H02J 7/06; H02J 7/0013; H02M 1/4225; H02M 3/01; H02M 3/33573; H02M 3/33592; H02J 7/00711; H02J 2207/20

(57) ABSTRACT

Battery pack chargers for charging a battery pack include one or more battery pack receiving portions, a power control module, and a power conversion unit. The one or more battery pack receiving portions receive and interface with the battery pack. The battery pack includes one or more battery cells. The power control module provides power to the one or more battery pack receiving portions using pulse amplitude modulation (PAM). The power conversion unit converts the power received from the first external source to a first DC power used for charging the one or more battery cells.

### RELATED APPLICATIONS

This application claims the benefit of U.S. Provisional Patent Application No. 63/270,601, filed Oct. 22, 2021, the entire content of which is hereby incorporated by reference.

### FIELD

Embodiments described herein provide a battery pack charger.

### SUMMARY

Battery chargers are gaining importance in many industrial and commercial applications, including power tools, automobiles, and home and garden uses. Traditionally, battery chargers use an alternating current (AC) source to charge batteries. When using an AC source to charge batteries, energy flows from the AC source to a holding direct current (DC) storage system, including bulk capacitors or other energy storage components. The energy across the bulk capacitor is converted into a high frequency AC voltage using a pulse width modulation (PWM) circuit powering a high frequency (HF) transformer. The secondary of the HF transformer can then be rectified and fed into the battery. The output DC voltage is made variable by controlling the pulse width on the primary side of the HF transformer.

In contrast to the traditional Pulse Width Modulation method, an alternate method to charge the battery is provided. Specifically, instead of varying the pulse width to produce variable DC voltage at the secondary of the HF transformer, the voltage amplitude at the primary side of the HF transformer is directly varied, which will yield the same desired variable DC voltage across the secondary windings of the HF transformer. The advantage to this approach is that the switches that control the operation of the HF transformer need not be modulated, and the switches can then operate at their optimal duty cycle corresponding to the highest efficiency point of operation. Further, tests have shown that the EMI footprint is also the lowest at this optimal operating point for the DC-to-DC Converter. Using the method of modulating the voltage amplitude on the primary side of the HF transformer to achieve desired variable DC voltage at the output of the DC-to-DC converter is referred to herein as Pulse Amplitude Modulation (PAM), and can be implemented instead of the traditional Pulse Width Modulation (PWM).

Various charging methodologies can be used for charging batteries. For example, depending on the state of charge (SOC) of the battery, a battery can initially be charged using constant current (CC) mode and later using constant voltage (CV) mode. Traditionally, such a charging methodology involves two stages of power conversion, the AC to fixed DC voltage stage, and a Pulse Width Modulated DC-to-DC converter stage that charges the battery. Control signals can be used in the first AC to DC stage to yield a variable DC voltage instead of the fixed DC voltage, as performed traditionally. This shift in the control strategy allows the second DC to DC converter stage to be simply a fixed non-modulated switching converter that facilitates conversion of DC voltage to high frequency AC voltage so that it can be isolated, and level translated (transformed) by the fixed turns ratio of the HF transformer.

Embodiments described herein provide for pulse amplitude modulated charging of battery packs, such as power tool battery packs.

Battery pack chargers described herein for charging a battery pack include one or more battery pack receiving portions, a power control module, and a power conversion unit. The one or more battery pack receiving portions receive and interface with the battery pack. The battery pack includes one or more battery cells. The power control module provides power to the one or more battery pack receiving portions using pulse amplitude modulation (PAM). The power conversion unit converts the power received from a first external source to a first DC power used for charging the one or more battery cells.

In some aspects, the power conversion unit includes an AC-to-DC rectifier, a power factor correction (PFC) converter, and a DC-to-DC converter.

In some aspects, the PFC converter is a boost converter including a gate driver.

In some aspects, an output of the PFC converter is controlled based on a state of charge (SOC) of the battery pack.

In some aspects, the DC-to-DC converter includes a high frequency transformer. The high frequency transformer includes at least one primary-side winding.

In some aspects, the DC-to-DC converter also includes a resonant converter coupled to the high frequency transformer. The DC-to-DC converter is configured to operate at a fixed frequency.

In some aspects, the DC-to-DC converter also includes a full bridge PAM inverter. The full bridge PAM inverter is coupled to the high frequency transformer.

In some aspects, the high frequency transformer is configured to operate at a duty cycle fixed substantially at or close to 50%.

In some aspects, the high frequency transformer includes at least a first primary-side winding and a second primary-side winding.

In some aspects, the high frequency transformer includes a contactor connected between first primary-side winding and the second primary-side winding.

In some aspects, the high frequency transformer includes at least two secondary-side windings that include different turn ratios.

In some aspects, the high frequency transformer includes a selector switch associated with to the at least two secondary-side windings.

In some aspects, a first end of each of the at least two secondary-side windings are electrically connected.

In some aspects, the DC-to-DC converter includes a plurality of insulated-gate bipolar transistors (IGBT).

In some aspects, the DC-to-DC converter is a switched capacitor DC-to-DC converter.

Portable power supplies described herein for charging a battery pack include a power output panel, a power control module, and a power conversion unit. The power output panel provides power to the battery pack. The battery pack includes one or more battery cells. The power output panel also provides a connection between the portable power supply and the battery pack. The power control module also provides power to the power output panel using pulse amplitude modulation (PAM). The power conversion unit converts the power received from a first internal source to a first DC power used for charging the one or more battery cells.

In some aspects, the power conversion unit includes an AC-to-DC rectifier, a power factor correction (PFC) converter, and a DC-to-DC converter.

In some aspects, the PFC converter is a boost converter including a gate driver.

In some aspects, an output of the PFC converter is controlled based on a state of charge (SOC) of the battery pack.

In some aspects, the DC-to-DC converter includes a high frequency transformer. The high frequency transformer includes at least one primary-side winding.

In some aspects, the DC-to-DC converter also includes a resonant converter coupled to the high frequency transformer. The DC-to-DC converter is configured to operate at a fixed frequency.

In some aspects, the DC-to-DC converter also includes a full bridge PAM inverter. The full bridge PAM inverter is coupled to the high frequency transformer.

In some aspects, the high frequency transformer is configured to operate at a duty cycle fixed substantially at or close to 50%.

In some aspects, the high frequency transformer includes at least a first primary-side winding and a second primary-side winding.

In some aspects, the high frequency transformer includes a contactor connected between first primary-side winding and the second primary-side winding.

In some aspects, the DC-to-DC converter includes a plurality of insulated-gate bipolar transistors (IGBT).

In some aspects, the DC-to-DC converter is a switched capacitor DC-to-DC converter.

Methods described herein for charging a battery pack include connecting the battery pack to a battery pack charger, providing a charging current to one or more battery cells of the battery pack, and providing a fixed square wave inverter signal to a DC-to-DC converter.

In some aspects, the method includes maintaining a contactor in an ON state. The method also includes monitoring a cell voltage of the one or more battery cells within the battery pack. The method further includes changing the contactor to an OFF state when the cell voltage of the one or more battery cells is below a threshold value.

In some aspects, the contactor increases a turns ratio of a primary-side transformer when in the OFF state.

In some aspects, the method includes determining that the cell voltage of the one or more battery cells is greater than or equal to the threshold value. The method further includes changing the contactor to the ON state.

Systems described herein for charging a battery pack include the battery pack and a battery pack charger. The battery pack includes one or more battery cells. The battery pack charger includes one or more battery pack receiving portions, a power control module, a power conversion unit, and an electronic processor. The one or more battery pack receiving portions interface with the battery pack. The power control module provides power to the one or more battery pack receiving portions using pulse amplitude modulation (PAM). The power conversion unit converts the power received from a first external source to a first DC power. The electronic processor is connected to the power control module. The electronic processor monitors a parameter of the battery pack and controls power provided to the battery pack based on the parameter and a threshold for the parameter.

In some aspects, the electronic processor controls the power provided to the battery pack based on the parameter and the threshold by changing a charging profile.

In some aspects, the power conversion unit includes an AC-to-DC rectifier, a power factor correction (PFC) converter, and a DC-to-DC converter.

In some aspects, the PFC converter is a boost converter including a gate driver.

In some aspects, the electronic processor varies an output of the PFC converter based on a state of charge (SOC) of the battery pack.

In some aspects, the DC-to-DC converter includes a high frequency transformer including at least one primary-side winding.

In some aspects, the DC-to-DC converter includes a resonant converter coupled to the high frequency transformer and configured to operate at a fixed frequency.

In some aspects, the DC-to-DC converter includes a full bridge PAM inverter coupled to the high frequency transformer.

In some aspects, the electronic processor operates the high frequency transformer at a duty cycle fixed substantially at or close to 50%.

In some aspects, the high frequency transformer includes at least a first primary-side winding and a second primary-side winding.

In some aspects, the high frequency transformer includes a contactor connected between the first primary-side winding and the second primary-side winding.

In some aspects, the high frequency transformer includes at least two secondary-side windings that include different turn ratios.

In some aspects, the high frequency transformer includes a selector switch associated with the at least two secondary-side windings.

In some aspects, a first end of each of the at least two secondary-side windings are electrically connected.

In some aspects, the DC-to-DC converter includes a plurality of insulated-gate bipolar transistors (IGBT).

In some aspects, the DC-to-DC converter is a switched capacitor DC-to-DC converter.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Other aspects of the embodiments will become apparent by consideration of the detailed description and accompanying drawings.

### BRIEF DESCRIPTION OF THE DRAWINGS

FIG. 1 is a perspective view of a battery pack charger according to embodiments described herein.

FIG. 2 is an electromechanical diagram of a controller for the battery pack charger of FIG. 1 according to embodiments described herein.

FIG. 3 is an example circuit for implementing charging schemes according to embodiments described herein.

FIG. 4 is an example circuit for implementing charging schemes according to embodiments described herein.

FIGS. 5A and 5B are example circuits for implementing charging schemes according to embodiments described herein.

FIGS. 6A and 6B are example circuits for implementing charging schemes according to embodiments described herein.

FIGS. 7A, 7B, and 7C are example circuits for implementing charging schemes according to embodiments described herein.

FIG. 8 is a perspective view of a battery pack according to an embodiments described herein.

FIG. 9 is a perspective view of a battery pack according to an embodiments described herein.

FIG. 10 is a perspective view of a battery pack according to an embodiments described herein.

FIG. 11 is a perspective view of a power supply according to an embodiments described herein.

FIG. 12 is an example DC-to-DC converter for implementing charging schemes according to embodiments described herein.

FIG. 13 is an example DC-to-DC converter for implementing charging schemes according to embodiments described herein.

FIG. 14 illustrates an example flow chart for implementing a charging scheme according to embodiments described herein.

FIG. 15 illustrates an example flow chart for implementing a charging scheme according to embodiments described herein.

FIG. 16 illustrates an example circuit for employing a charging scheme for charging a battery pack according to embodiments described herein.

FIG. 17 illustrates an example circuit for employing a charging scheme for charging a battery pack according to embodiments described herein.

### DETAILED DESCRIPTION

The present disclosure provides alternate methods for charging battery packs over traditional charging methodologies. A first charging methodology, among other things, reduces the stresses on a second stage of power conversion. A second charging methodology, among other things, significantly reduces a Volt-Ampere (VA) rating of a power converter in a battery pack charger.

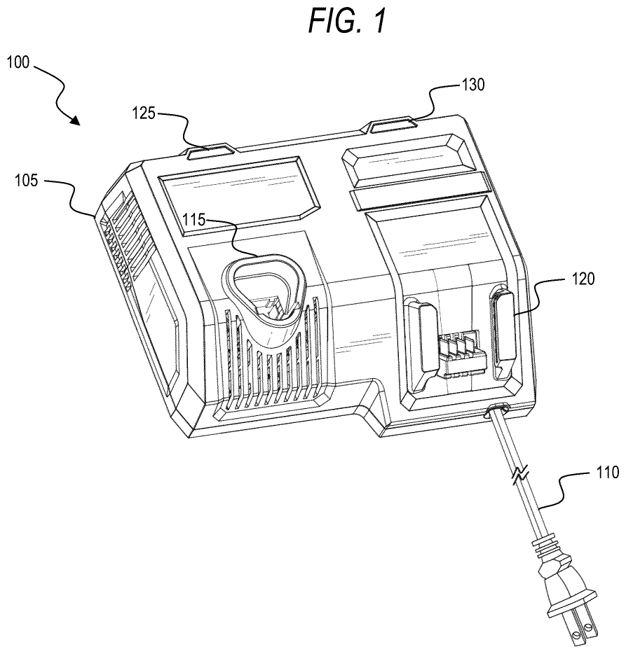

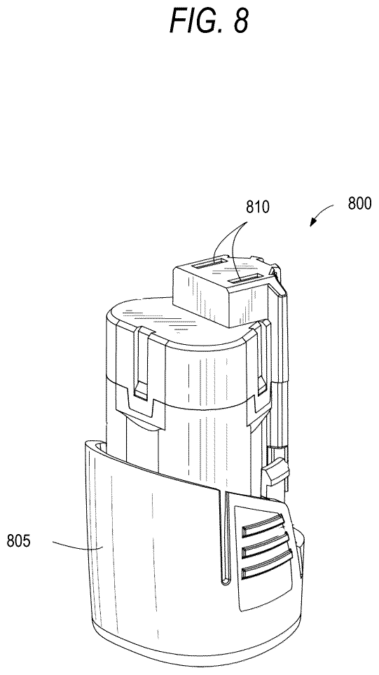

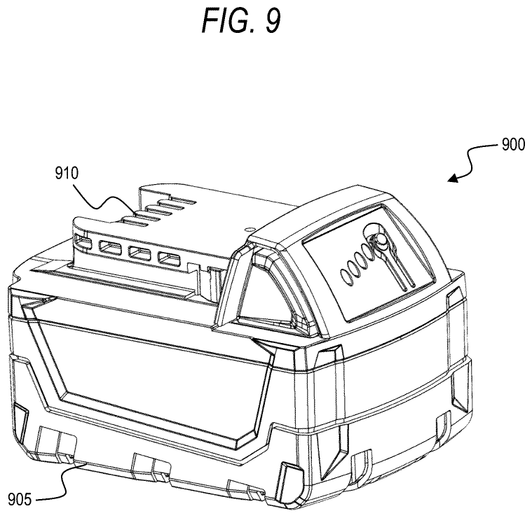

FIG. 1 illustrates a battery pack charger or charger 100. The battery pack charger 100 includes a housing portion 105 and an AC input power plug 110. The battery pack charger 100 can be configured to charge one or more battery packs having one or more nominal voltage values. For example, the battery pack charger 100 illustrated in FIG. 1 is configured to charge a first type of battery pack using a first battery pack receiving portion or interface 115 and a second type of battery pack using a second battery pack receiving portion or interface 120. The first type of battery pack is, for example, a 12V battery pack having a stem that is inserted into the first battery pack receiving portion or interface 115, as shown in FIG. 8. The second type of battery pack is, for example, an 18V battery pack having a plurality of rails for slidably attaching the battery pack in the second battery pack receiving portion or interface 120, as shown in FIG. 9. In some embodiments, the charger 100 can include an AC adaptor for plugging into an AC power outlet and into a charging port on a device to be charged. Any combination of battery pack chargers can be used without departing from the scope of the present disclosure. In some embodiments, the battery pack charger 100 includes one or more indicators 125, 130 for providing visual feedback to a user as to the charging status of the attached battery packs.

Regardless of designs, the battery packs can each include a plurality of lithium-based battery cells having a chemistry of, for example, lithium-cobalt (“Li—Co”), lithium-manganese (“Li—Mn”), or Li—Mn spinel. In some embodiments, the battery cells have other suitable lithium or lithium-based chemistries, such as a lithium-based chemistry that includes manganese, etc. The battery cells within each battery pack are operable to provide power (e.g., voltage and current) to one or more power tools. Although the present disclosure is discussed with respect to lithium batteries, any type of batteries can be used.

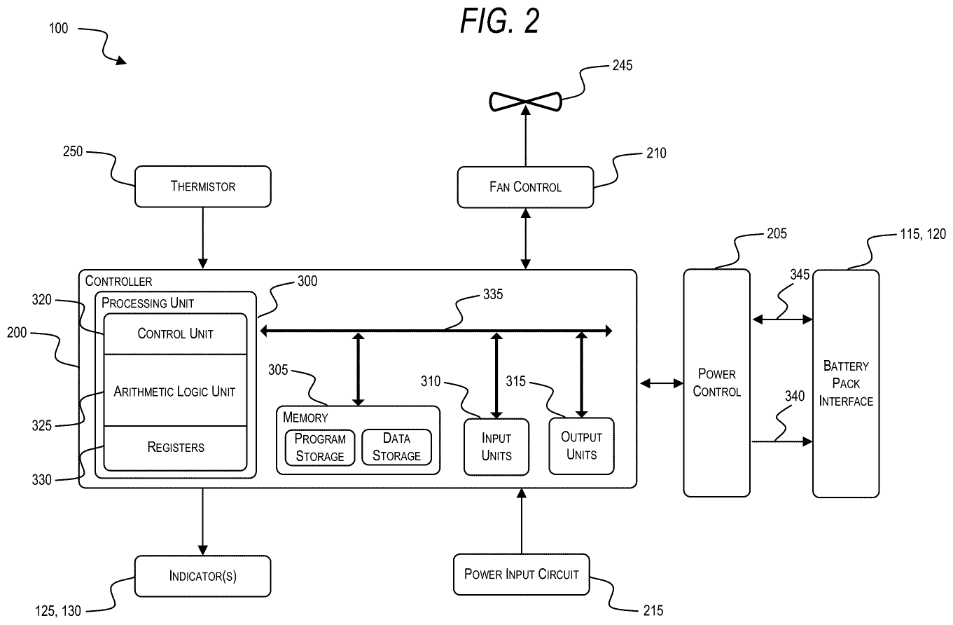

The charger 100 includes a controller 200 for implementing one or more charging schemes. An example of the controller 200 for the battery pack charger 100 is illustrated in FIG. 2. The controller 200 is electrically and/or communicatively connected to a variety of modules or components of the battery pack charger 100. For example, the illustrated controller 200 is connected to the first and second battery pack portions or interface(s) 115, 120 through a power control module 205. The controller 200 can include or otherwise be in communication with the indicators 125, 130, a fan control module 210, a power input circuit 215, and a thermistor 250. The controller 200 includes combinations of hardware and software that are operable to, among other things, control the operation of the battery pack charger 100, activate the indicators 125, 130 (e.g., one or more LEDs), estimate the temperature of a first heatsink, measure the temperature of a second heatsink, etc.

The controller 200 includes a plurality of electrical and electronic components that provide power, operational control, and protection to the components and modules within the controller 200 and/or battery pack charger 100. For example, the controller 200 includes, among other things, a processing unit 300 (e.g., an electronic processor, a microprocessor, a microcontroller, or another suitable programmable device), a memory 305, input units 310, and output units 315. The processing unit 300 includes, among other things, a control unit 320, an arithmetic logic unit (“ALU”) 325, and a plurality of registers 330 (shown as a group of registers in FIG. 2), and is implemented using a known computer architecture (e.g., a modified Harvard architecture, a von Neumann architecture, etc.). The processing unit 300, the memory 305, the input units 310, and the output units 315, as well as the various modules connected to the controller 200 are connected by one or more control and/or data buses (e.g., common bus 335). The control and/or data buses are shown generally in FIG. 2 for illustrative purposes. The use of one or more control and/or data buses for the interconnection between and communication among the various modules and components would be known to a person skilled in the art in view of the invention described herein.

The memory 305 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 300 is connected to the memory 305 and executes software instructions that are capable of being stored in a RAM of the memory 305 (e.g., during execution), a ROM of the memory 305 (e.g., on a generally permanent basis), or another non-transitory computer readable medium such as another memory or a disc. Software included in the implementation of the battery pack charger 100 can be stored in the memory 305 of the controller 200. The software includes, for example, firmware, one or more applications, program data, filters, rules, one or more program modules, and other executable instructions. The controller 200 is configured to retrieve from the memory 305 and execute, among other things, instructions related to the control processes and methods described herein. In other constructions, the controller 200 includes additional, fewer, or different components.

The battery pack interface(s) 115, 120 includes a combination of mechanical components and electrical components configured to and operable for interfacing (e.g., mechanically, electrically, and communicatively connecting) the battery pack charger 100 with a battery pack. For example, the battery pack interface(s) 115, 120 is configured to receive power from the power control module 205 via a power line 340 between the power control module 205 and the battery pack interface(s) 115, 120. The battery pack interface(s) 115, 120 is also configured to communicatively connect to the power control module 205 via a communications line 345.

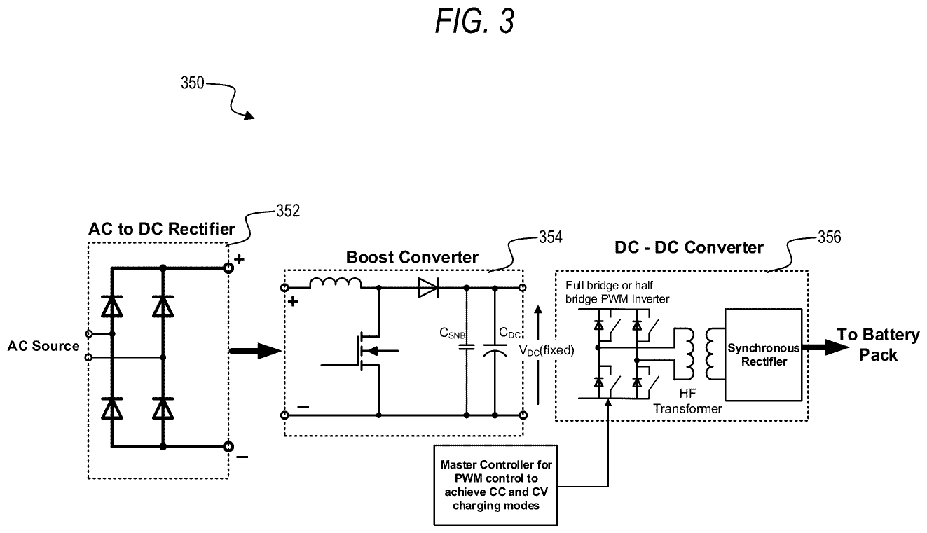

Referring to FIG. 3, a circuit 350 for implementing a pulse width modulation (PWM) charging scheme using the charger 100 is depicted. FIG. 3 shows an example circuit 350 including a DC-to-DC converter scheme used in conjunction with a power factor correction topology to achieve a variable DC voltage for charging Li-ion batteries. In some embodiments, the circuit 350 includes a two-stage power conversion including a power factor correction (PFC) converter 354 (or boost converter) and a DC-to-DC converter 356 using a high frequency (HF) transformer. In the first stage, power is provided from an AC power source into an AC-to-DC rectifier 352. The input AC is converted into a fixed DC bus voltage, typically using the PFC converter 354 to assure good input power factor and low current harmonics. For example, the DC-to-DC converter 356 can convert DC power output at a first voltage level (e.g., 120V) by the PFC converter 354 to a voltage level (e.g., 36V, 72V, 120V, 280V, etc.) used to charge a battery pack(s). In some embodiments, the DC-to-DC converter 356 is a single converter circuit. In some embodiments, the DC-to-DC converter 356 is implemented as more than one converter circuit.

In some embodiments, the PFC converter 354 and/or the DC-to-DC converter 356 is a boost converter configured to increase the voltage level of DC power output by PFC converter 354 to a voltage level used to charge the battery pack(s). The output of the PFC converter 354 can be fixed at some high enough voltage to realize boost operation even under light load conditions. In the second stage, the fixed output voltage from the PFC converter 354 is fed into a high frequency Switched Mode Power Supply (SMPS) transformer of the DC-to-DC converter 356 to convert the fixed DC voltage to a pulse width modulated bidirectional voltage across the primary of the SMPS transformer. The output of the SMPS transformer is rectified, for example using a synchronous rectifier, which is then fed into the battery pack to charge to charge the battery pack, in either constant current or constant voltage mode, depending on the state of charge (SOC) of the battery pack.

In some embodiments, the output voltage of the SMPS of the DC-to-DC converter 356 is controlled by controlling the pulse width of the switches in the primary of the DC-to-DC converter 356. The DC-to-DC converter 356 topology can either be a full or half bridge converter or a forward converter, depending on the desired power level, cost, and size constraints. In some embodiments, as depicted in FIG. 3, a full bridge or half bridge DC-to-DC converter 356 with HF transformer for isolation is used. In this configuration, the output of HF transformer is rectified and used for charging the battery pack in either CC or CV mode. By using a phase shift full bridge converter, zero voltage switching can be achieved.

In some embodiments, the controller 200 can provide a pulse width modulation (PWM) control to the DC-to-DC converter to achieve the desired constant current (CC) or constant voltage (CV) charging modes. Pulse width modulation of primary side switches may reduce efficiency over a charging range and increases an electromagnetic interference (EMI) footprint of the charger 100. However, the fundamental principle behind the operation of the DC-to-DC converter is the pulse width modulation which allows the control of the rectified DC voltage at the output of the secondary of the DC-to-DC converter 356. In some embodiments, the output of the PFC converter 354 can be fixed at about 400V for universal use, although ratio of transformation in North American can be high and may reduce efficiency while increasing EMI since voltage across the PFC converter 354 and MOSFET is high. The circuit 550 can be used, for example, in North America or the rest of the world without having to modify the operation range of the PFC converter 554 because the input voltage for rest of the world is high. Since the battery pack voltage is same, the HF transformer turns ratio should be changed to allow a higher primary voltage and the same secondary voltage as needed by the battery pack, as discussed in greater detail herein.

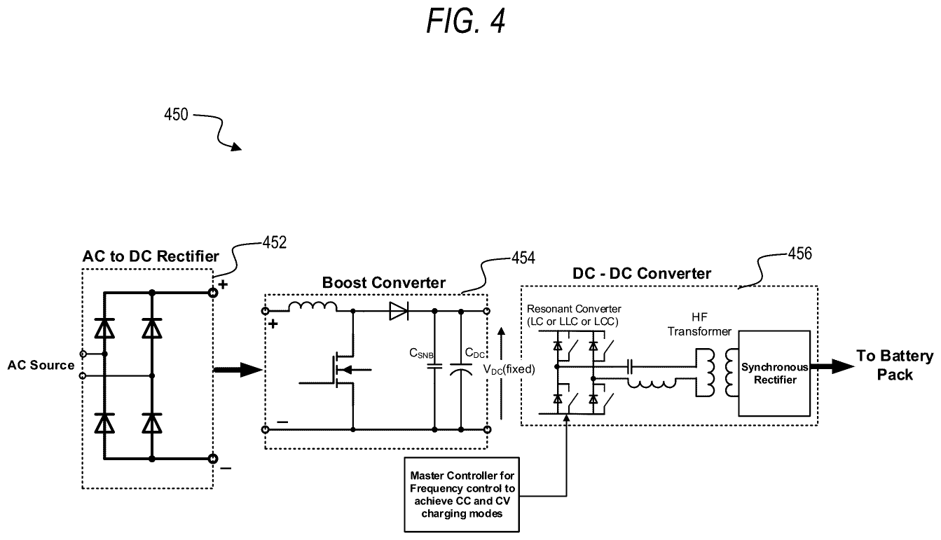

Referring to FIG. 4, a circuit for implementing a frequency modulation method for a resonant converter charging scheme using the charger 100 is depicted. FIG. 4 shows a circuit 450, with the DC-to-DC converter 456 including a resonant LLC topology. Some higher power chargers use a resonant converter, either the LLC or the LC series resonant converters. LLC converters are efficient and have a relatively high-power density when compared to other DC-to-DC converters and are well suited for providing a wide range of output voltage levels.

The circuit 450 in FIG. 4 may be preferable for higher power applications. Similar to FIG. 3, FIG. 4 shows an example circuit including a DC-to-DC converter scheme used in conjunction with a power factor correction topology to achieve a variable DC voltage for charging a battery pack. In some embodiments, the circuit 450 includes a two-stage power converter including a power factor correction (PFC) converter and a DC-to-DC converter using a HF transformer. In the first stage, power is provided from an AC power source into an AC-to-DC rectifier 452. The input AC is converted into a fixed DC bus voltage, typically using the PFC topology included within the PFC converter 454 to assure good input power factor and low current harmonics. For example, the DC-to-DC converter 456 can convert DC power output at a first voltage level (e.g., 120V) by the PFC converter 454 to a voltage level (e.g., 36V, 72V, 120V, 280V, etc.) used to charge a battery pack(s). In some embodiments, the PFC converter 454 is a boost converter configured to increase the voltage level of DC power output by the PFC converter 454 to a voltage level used to charge the battery pack(s). The output of the PFC converter 454 can be fixed at some high enough voltage to realize boost operation even under light load conditions. In the second stage, the output voltage from the PFC converter 454 is fed into a high frequency Switched Mode Power Supply (SMPS) transformer of the DC-to-DC converter 456 to convert the fixed DC voltage to a pulse width modulated bidirectional voltage across the primary of the SMPS transformer. The output of the SMPS transformer is rectified, for example, using a synchronous rectifier, which is then fed into the battery pack to charge it, in either constant current or constant voltage mode, depending on the state of charge (SOC) of the battery pack.

In some embodiments, the output voltage of the DC-to-DC converter 456 is controlled by controlling the frequency of the switches in the primary of the DC-to-DC converter 456. The DC-to-DC converter 456 topology can either be a full bridge or half bridge converter feeding a resonant topology. In the half bridge version, the capacitors used to split the DC bus voltage into two equal parts often forms the resonating capacitor. The choice to use full bridge or half bridge topology depends on the desired power level, cost, and size constraints. Thereafter, an output of the HF transformer is rectified. However, resonant operation can cause high peak voltages across output rectifier diodes, forcing use of high voltage components.

In some embodiments, the controller 200 can provide a frequency modulation (FM) control to the DC-to-DC converter to achieve the desired constant current (CC) or constant voltage (CV) charging modes. The fundamental principle behind the operation of a resonant converter-based DC-to-DC converter is the frequency modulation which allows the control of the rectified DC voltage at the output of the secondary of the SMPS transformer 456. In some embodiments, the output of the PFC can be fixed at about 400V for universal use. Frequency modulation is used when input voltage to output voltage range is large, and the resonant converter operation needs to operate over a wide frequency range. This configuration may be inefficient, with higher EMI and non-optimized LC components. If the topology uses resonant converters, as depicted in FIG. 4, then frequency modulation is used instead of pulse width modulation.

In both circuits 350, 450, the output of the PFC converter is kept fixed and is fed into the DC-to-DC converter 356, 456. The pulse width or the frequency of the switches in the DC-to-DC converter 356, 456 is manipulated to yield constant current or constant voltage characteristics at the output so as to charge the battery pack. However, modulating the primary side voltage may result in unfavorable performance from both an EMI point of view and from an efficiency point of view.

In contrast to the circuits 350 and 450, optimal performance of a DC-to-DC converter is achieved when it operates at close to a square wave input using an approximately 50% modulation scheme for each leg of the full bridge converter. If the pulse width is kept constant, then the EMI signature can be easily controlled, and methods can be adopted to reduce its influence. Further, the operating efficiency may increase significantly since the transformer operates with no DC flux and at a fixed frequency. Similarly, operating a resonant converter at its optimal resonant frequency assures maximum utilization of the components, best operating efficiency, and a significant reduction in its EMI signature.

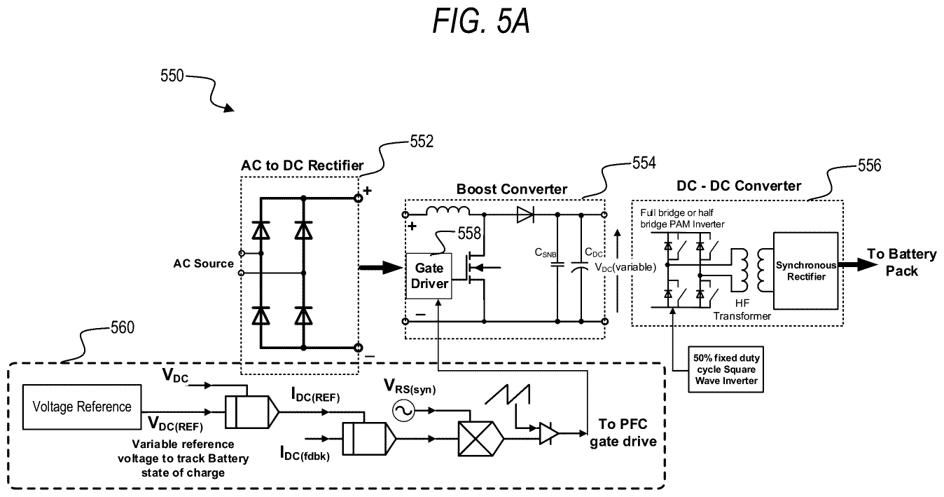

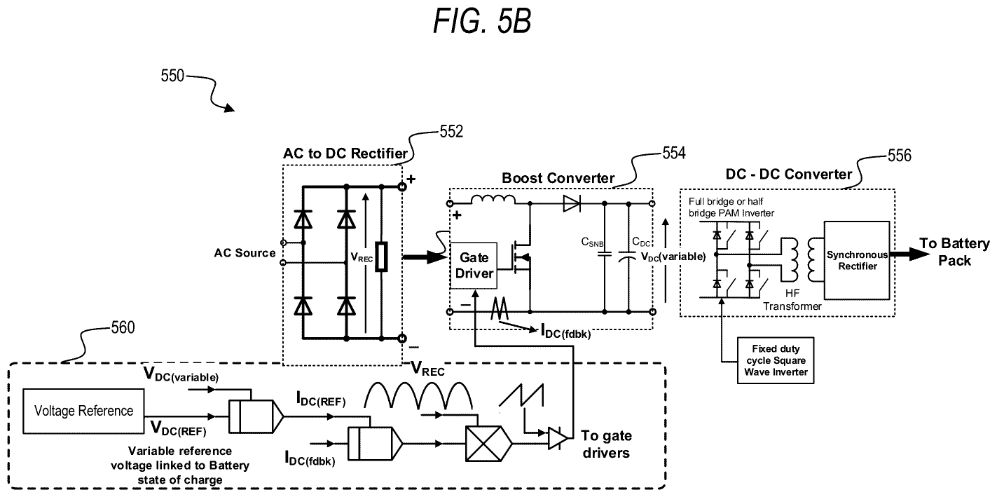

Referring to FIG. 5A, in some embodiments, a circuit 550 for implementing a pulse amplitude modulation (PAM) charging scheme using the charger 100 is depicted. FIG. 5A shows an example circuit 550 including a DC-to-DC converter scheme used in conjunction with a power factor correction (PFC) topology to achieve a variable DC voltage for charging battery packs. The circuit 550 can be similar in design and function as the circuit 350 discussed with FIG. 3, but with the addition of a gate driver 558 within and/or coupled to the PFC converter 554. The circuit 550 can include a power conversion unit including an AC-to-DC rectifier 552, a PFC converter 554 (or boost converter), and a DC-to-DC converter 556.

In some embodiments, the circuit 550 includes components to alter the operation of the PFC converter 554 so that the output is varied to mimic the desired voltage to charge the battery pack by following the battery charging voltage reference circuit and altering the duty cycle of the PFC converter 554 so that the PFC output is not fixed but follow the state of charge (SOC) of the battery pack. For example, the controller 200 can implement the battery charging voltage reference circuit that tracks the SOC of a battery pack and modifies the duty cycle of the PFC converter 554 to correspond to the SOC. This is achieved using a modulation circuit 560 to control the duty cycle of the PFC converter 554. In some embodiments, a minimum output voltage value for the PFC converter 554 can be set to ensure PFC operation. To achieve the needed DC voltage, which varies depending on the state of charge of the battery pack, the duty cycle of the PFC converter 554 is controlled. For a 120V AC input, for example, the lowest voltage at the output of the PFC converter 554 is 180V DC.

The variable DC voltage output by the PFC converter 554 is fed into a HF transformer-based DC-to-DC converter 556 to isolate the varying DC voltage. In some embodiments, the HF transformer-based DC-to-DC converter 556 is made to switch at a duty cycle of close or equal to 50% duty cycle if it is hard switched using a full bridge or half bridge converter topology. For example, the HF transformer is operated at a fixed duty cycle of about 50% with a square wave inverter operation, as shown in FIG. 5A. The combination of the varied output of the PFC converter 554 and the fixed duty cycle of about 50% of the DC-to-DC converter 556 improves efficiency, makes EMI deterministic, allows for optimal EMI filter design, and reduces stress on rectifier diodes in the HF transformer secondary stage of power conversion to reduce the overall Volt-Ampere (VA) rating of the power converter. Therefore, keeping either the pulse width at a maximum (e.g., 50%) duty cycle and/or keeping the switching frequency in a resonant converter fixed, yields optimal performance with highest efficiency, and reduced conducted and radiated EMI.

In some embodiments, a turns ratio of the HF transformer is selected assuming square wave operation if a full bridge converter is used. Since the turns-ratio will not change, the needed DC voltage is determined based on a SOC of a battery pack and this information is used to vary the duty cycle of the PFC converter 554. In FIG. 5A, the secondary of the HF transformer is shown to have only one set of winding. The turns ratio is determined depending on the type of battery pack being charged. If a different pack needs to be charged, a different turns ratio will be needed. The lowest voltage needed at the output of the transformer is first calculated. The turns ratio is then set such that at the lowest pack voltage, PFC operation is maintained.

FIG. 5B depicts an example schematic of a control scheme to achieve variable DC output voltage from PFC converter that tracks the state of charge of the battery pack. PFC output feeds a full/half bridge DC-to-DC converter operating at its optimal duty cycle, which is typically close to 50%.

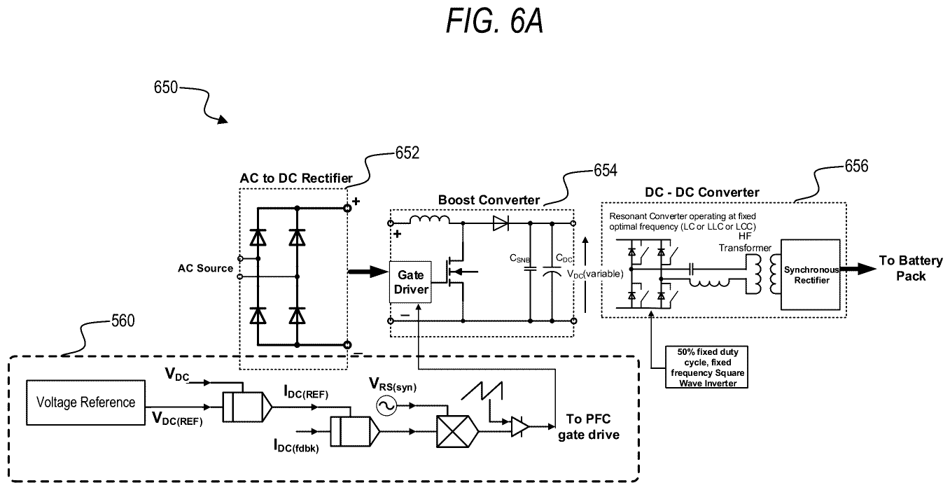

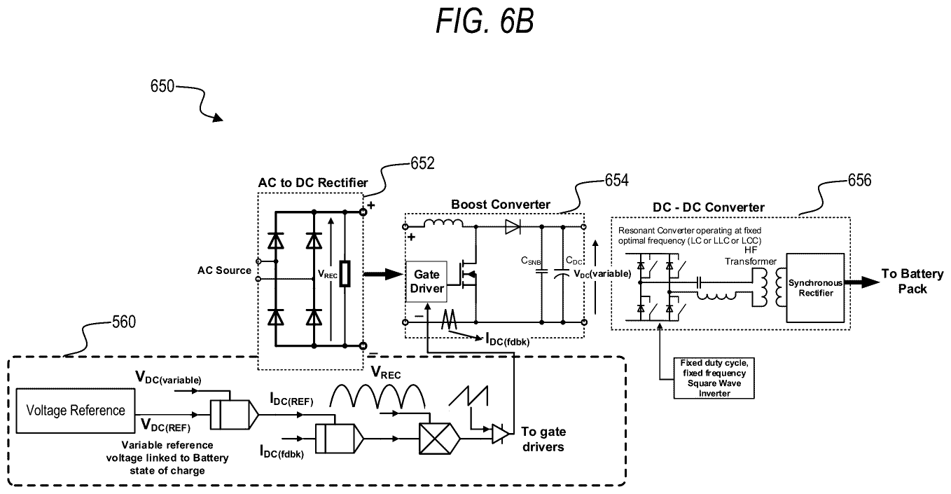

In some embodiments, the battery charging voltage reference circuit is configured to determine a desired voltage, which includes checking the state of charge of the battery pack (e.g., to determine present state of charger, determine nominal voltage, etc.), the operating temperature (e.g., is the operating temperature within an acceptable charging range, etc.), and the desired charging current (e.g., fast charge current, slow charge current, etc.) (see, e.g., TABLES 1-5 below). Based on the state of charge, operating temperature, and desired charging current, the battery charging voltage reference circuit causes the desired DC voltage to be generated at the secondary of the HF transformer, which is translated to the primary side, depending on the turns ratio of the HF transformer. The desired voltage determined by the battery charging voltage reference circuit is labeled V_{DC(REF)} in the modulation circuit 560. In some embodiments, the V_{DC(REF)} signal is compared with the actual DC bus voltage at the output of the power factor correction (PFC) circuit, which is denoted as V_{DC(variable)} in the modulation circuit 560. The error signal becomes the current reference signal (I_{DC(REF)}) to control the current through the PFC. The PFC current (I_{DC(fbbk)}) can be measured, using any combination of methods used in a PFC circuit. For example, as depicted in FIG. 6B, the PFC current (I_{DC(fbbk)}) can be read from the boost converter 554. The error between the measured current (I_{DC(fbbk)}) and the desired current (I_{DC(REF)} forms the actual control signal which is numerically multiplied by the shape of the current that should flow through the PFC, which is a rectified signal of the supply voltage.

In some embodiments, as shown in FIG. 5B, the battery charging voltage reference circuit includes sensing the rectified voltage of the input AC supply. When a DC level is multiplied by this rectified AC supply voltage, the amplitude of this rectified signal changes without changing the shape of the signal. This rectified signal is compared with either a saw tooth voltage waveform or a triangle voltage waveform to determine the actual pulse width to control the PFC MOSFET. The resulting control signal is then fed into the gate driver to control the MOSFET in the PFC. Since the battery voltage changes as the battery gets charged, the level of the signal that is used to multiply to the rectified AC changes, and so the pulse width of the MOSFETs in the PFC changes, thereby changing the level of the output DC voltage from the PFC.

Referring to FIG. 6A, in some embodiments, the charger 100 and charging schemes can be adapted for pulse amplitude modulation (PAM) with resonant DC-to-DC converter 656. The example circuit 650 shown in FIG. 6A includes an AC-to-DC rectifier 652, a PFC converter 654, and a DC-to-DC converter 656. The circuit 650 is similar to the circuit 550 discussed with respect to FIG. 5A but with a resonant converter in place of the full bridge or half bridge inverter within the DC-to-DC converter 656. In some embodiments, the resonant converter is operated at optimal resonant frequency (LC, LLC, or LCC) and no frequency modulation is needed to control the secondary voltage since PAM is used. By keeping the operating frequency fixed, resonant converter can be designed to operate at its highest efficiency and lowest EMI footprint. If a resonant converter is used as the preferred topology for the DC-to-DC converter 656, then the switching frequency of the switches in the DC-to-DC converter 656 is held constant at an optimal switching frequency. Holding the switching frequency at an optimal switching frequency helps achieve the best operating efficiency, lowest and manageable EMI footprint, and deterministic values for the EMI filter needed to meet certain industry guidelines.

FIG. 6B depicts an example schematic of a control scheme to achieve variable DC output voltage from PFD converter that tracks the state of charge of the battery pack. PFC output feeds a resonant converter-based DC-to-DC converter operating at its optimal frequency.

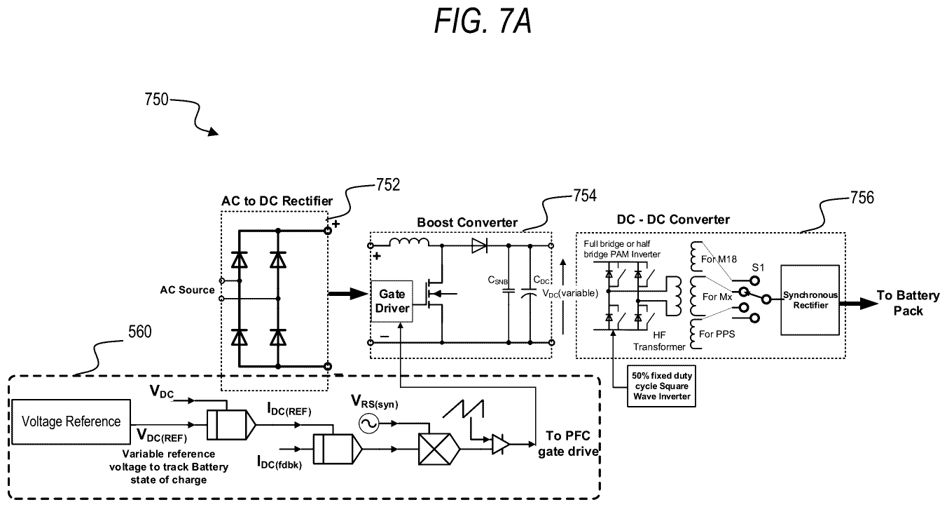

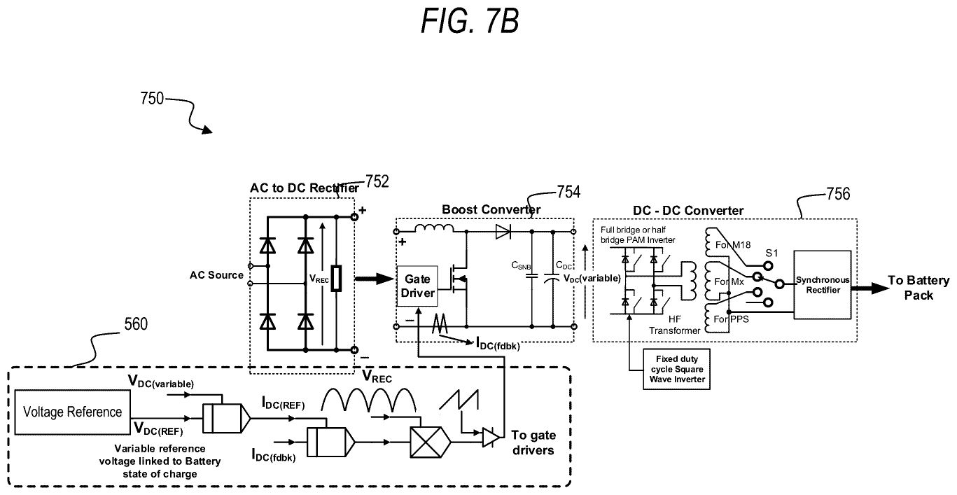

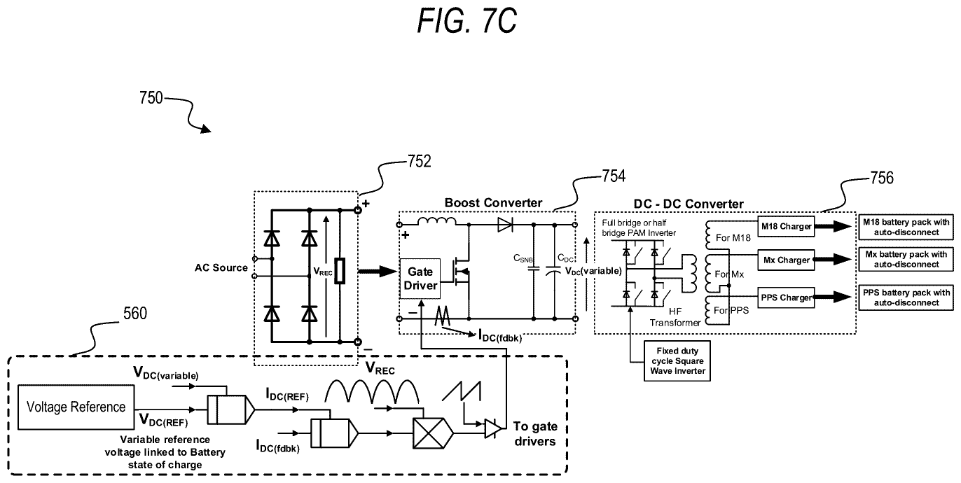

Referring to FIG. 7A, in some embodiments, the charger 100 can be implemented with different turns ratios for accommodating various battery packs with various voltages. For example, the charger 100 can be configured to receive and charge any combination of 36V, 72V, 120V, 280V, etc., battery packs. FIG. 7A shows an example circuit 750 for implementing the charging scheme discussed with respect to FIG. 5A to operate with various battery packs. The circuit 750 includes an AC-to-DC rectifier 752, a PFC converter 754, and a DC-to-DC converter 756. Although the circuit 750 is depicted as a modification to the circuit 550 discussed in FIG. 5A, any of the circuits 350, 450, 650 could be similarly modified to accommodate various battery packs. In some embodiments, the selector switching mechanism selects one of the many battery pack bays available to charge a particular pack in a given battery bay. The example circuit 750 shown in FIG. 7A includes similar components as the circuit 550 discussed with respect to FIG. 5A but with a switching mechanism included within the DC-to-DC converter 756 for adjusting a turns ratio for the corresponding battery pack type. For example, the HF transformer in the DC-to-DC converter 556 in FIG. 5A is setup with a single voltage winding for one particular battery type whereas the switching mechanism in the DC-to-DC converter 756 in FIG. 7A includes multiple secondary voltage windings with three different turn ratio options for three different battery pack types. Depending on the battery pack to be charged, the switching mechanism can be manually or automatically adjusted to provide the appropriate charging voltage for that battery pack as an output. Even if multiple secondary windings are provided, only one battery pack can be charged since the state of charge determines the output of the PFC converter 754.

Referring to FIG. 7B, in some embodiments, a charger can be configured to receive multiple different size/shaped battery packs at the same time which can be charged one at a time. FIG. 7B depicts an example schematic of an implementation for charging various battery packs, one at a time. Selector switch SI selects the desired battery to be charged, depending on the presence of a battery pack in a given bay.

Referring to FIG. 7C, in some embodiments, by connecting the ends of each winding together, it is possible to allow multiple battery packs to be charged simultaneously in a multiple bay charger, for example, as depicted in FIG. 1. The battery packs can be the same size/type battery packs or different sized/type battery packs. FIG. 7C depicts an example schematic of possible implementation for charging various battery packs simultaneously. In the configuration shown in FIG. 7C, no selector switch is used and the battery charging voltage reference circuit starts from its lowest boost level, for example, 180 VDC for a 120 VAC system and 340 VDC for a 240 VAC system. When the boost converter is commanded to output 180 VDC, the voltage at the secondary of the DC-to-DC converter will assume the lowest possible value for the corresponding bay to which the secondary is connected. If the battery pack in one of the bays of the charger is at a higher voltage than that provided by the starting point for charging, no charging current will flow, and no charging will occur. The voltage at the output of the PFC is gradually increased and, as the voltage at the output of the PFC is increased, the battery pack(s) that has a voltage lower than that available at its bay will start charging. By default, the charging rate can be set at its lowest rate depending on the battery type that can be charged in the setup. Once a particular battery pack reaches full charge, it automatically deactivates its Charge Field Effect Transistor (CFET) and disconnects itself from the charger bay to which it was connected while the other battery packs can continue to charge.

FIG. 8 illustrates a battery pack 800 connectable to the charger 100 and connectable to and supportable by hand-held power tools, such as 12V power drills, fasteners, saws, pipe cutters, sanders, nailers, staplers, vacuum cleaners, blowers, etc. The battery pack 800 is also connectable to and supportable by outdoor power tools such as string trimmers, hedge trimmers, blowers, chain saws, etc. As shown in FIG. 8, the battery pack 800 includes a housing 805 and one or more rechargeable battery cells enclosed within the housing 805. The battery cells can be arranged in series, parallel, or a series-parallel combination. For example, the battery pack 800 can include a total of three battery cells configured in a series arrangement. In some embodiments, the battery pack 800 the housing 805 includes an interface portion 810 for connecting the battery pack 800 to a device (e.g., a power tool) or a battery pack charger 100 (e.g., via interface 115). In some embodiments, the lowest voltage of each of the cells is 2.5V and each battery cell having a nominal voltage of approximately 3.6V-4.2V, such that the battery pack 800 has a nominal voltage of approximately twelve volts (12V).

During charging of the battery pack 800, voltage drop across full bridge rectifier diodes is about 2V, voltage drop across secondary windings of HF transformer is about 1V. Therefore, the secondary voltage needed for charging the battery pack 800 is about 10.5V ([3 cells×lowest voltage of 2.5V]+2 voltage drop across bridge+1 voltage drop across HF transformer=10.5V). In some embodiments, the lowest primary voltage needed to maintain PFC converter operation is about 175V. Therefore, the required turns ratio for charging the battery pack 800 using the charging scheme discussed with respect to FIGS. 5 and 6 is 17. The turns ratio can be calculated by dividing the lowest primary voltage needed to maintain PFC converter operation of 175V by the secondary voltage needed for charging the battery pack 800 of 10.5V, which is 16.67, rounded up to 17. For a charging output of 10.5V, with turns ratio of 17, the PFC converter output voltage is about 178.5V (17×10.5V=178.5V). At maximum cell voltage of 4.2V, the secondary voltage needed for charging the battery pack 800 is about 15.6V ([3 cells×maximum voltage of 4.2V]+2 voltage drop across bridge+1 voltage drop across HF transformer=15.6V). With turns ratio of 17, PFC output voltage will go up to about 265.2V (17 turns×secondary voltage needed 15.6V=265.2V).

FIG. 9 illustrates a battery pack 900 connectable to the charger 100 and connectable to and supportable by hand-held power tools, such as 18V drills, fasteners, saws, pipe cutters, sanders, nailers, staplers, vacuum cleaners, blowers, etc. As shown in FIG. 9, the battery pack 900 includes a housing 905, and interface portion 910, and one or more rechargeable battery cells enclosed within the housing 905. The battery cells can be arranged in series, parallel, or a series-parallel combination. For example, the battery pack 900 can include a total of five battery cells configured in a series arrangement. A similar battery pack design can be implanted with ten rechargeable battery cells arranged in two rows of five or fifteen rechargeable battery cells arranged in five sets of three series-connected cells. In some embodiments, the battery pack 900 the housing 905 includes an interface portion 910 for connecting the battery pack 900 to a device (e.g., a power tool) or a battery pack charger 100 (e.g., via interface 120). In some embodiments, the lowest voltage of each of the cells is 2.5V and each battery cell having a nominal voltage of approximately 3.6V-4.2V, such that the battery pack 900 has a nominal voltage of approximately eighteen volts (18V).

During charging of the battery pack 900, voltage drop across full bridge rectifier diodes is about 2V, voltage drop across secondary windings of HF transformer is about IV. Therefore, the secondary voltage needed for charging the battery pack 800 is about 15.5V ([3 cells×lowest voltage of 2.5V]+2 voltage drop across bridge+1 voltage drop across HF transformer=15.5V). In some embodiments, the lowest primary voltage needed to maintain PFC converter operation is about 175V. Therefore, the required turns ratio for charging the battery pack 900 using the charging scheme discussed with respect to FIGS. 5 and 6 is 12. The turns ratio can be calculated by dividing the lowest primary voltage needed to maintain PFC converter operation of 175V by the secondary voltage needed for charging the battery pack 900 of 15.5V, which is 11.29, rounded up to 12. For a charging output of 15.5V, with turns ratio of 12, the PFC converter output voltage is about 186V (12×15.5V=186V). At maximum cell voltage of 4.2V, the secondary voltage needed for charging the battery pack 900 is about 24V ([5 cells×maximum voltage of 4.2V]+2 voltage drop across bridge+1 voltage drop across HF transformer=24V). With turns ratio of 12, PFC output voltage will go up to about 288V (12 turns×secondary voltage needed 24V=288V).

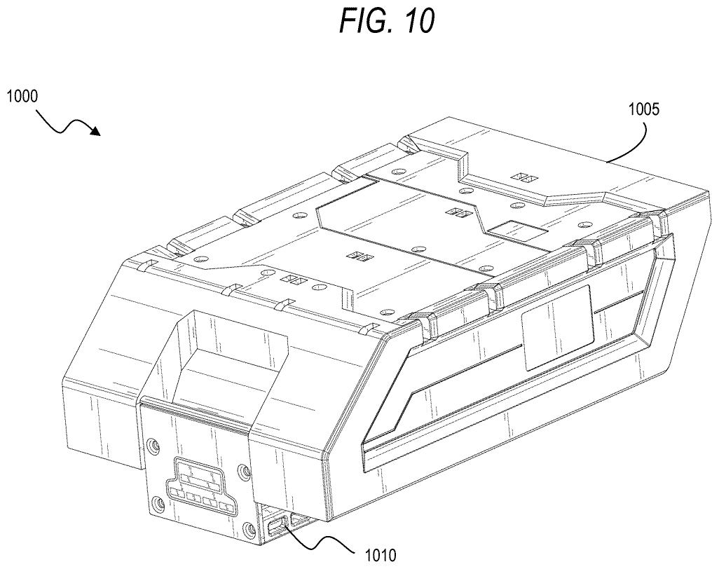

Referring to FIG. 10, a battery pack 1000 connectable to the charger 100 and connectable to and supportable by hand-held power tools, such as 72V-80V power drills, fasteners, saws, pipe cutters, sanders, nailers, staplers, vacuum cleaners, blowers, etc. The battery pack 800 is also connectable to and supportable by outdoor power tools such as string trimmers, hedge trimmers, blowers, chain saws, etc. As shown in FIG. 10, the battery pack 1000 includes a housing 1005, an interface portion 1010, and one or more rechargeable battery cells enclosed within the housing 1005. The battery cells can be arranged in series, parallel, or a series-parallel combination. For example, the battery pack 1000 can include a total of twenty battery cells configured in a series arrangement. In some embodiments, the lowest voltage of each of the cells is 2.5V and each battery cell having a nominal voltage of approximately 3.6V-4.2V, such that the battery pack 1000 has a nominal voltage of approximately eighty volts (80V).

During charging of the battery pack 1000, voltage drop across full bridge rectifier diodes is about 3V, voltage drop across secondary windings of hf transformer is about 2V. Therefore, the secondary voltage needed for charging the battery pack 1000 is about 55V ([20 cells×lowest voltage of 2.5V]+3 voltage drop across bridge+2 voltage drop across HF transformer=55V). In some embodiments, the lowest primary voltage needed to maintain PFC converter operation is about 175V. Therefore, the required turns ratio for charging the battery pack 1000 using the charging scheme discussed with respect to FIGS. 5 and 6 is 3.5. The turns ratio can be calculated by dividing the lowest primary voltage needed to maintain PFC converter operation of 175V by the secondary voltage needed for charging the battery pack 1000 of 55V, which is 3.18, rounded up to 3.5. For a charging output of 55V, with turns ratio of 3.5, the PFC converter output voltage is about 192.5V (3.5×55V=192.5V). At maximum cell voltage of 4.2V, the secondary voltage needed for charging the battery pack 1000 is about 89V ([20 cells×maximum voltage of 4.2V]+3 voltage drop across bridge+2 voltage drop across HF transformer=89V). With turns ratio of 3.5, PFC output voltage will go up to about 311.5V (3.5 turns×secondary voltage needed 89V=311.5V).

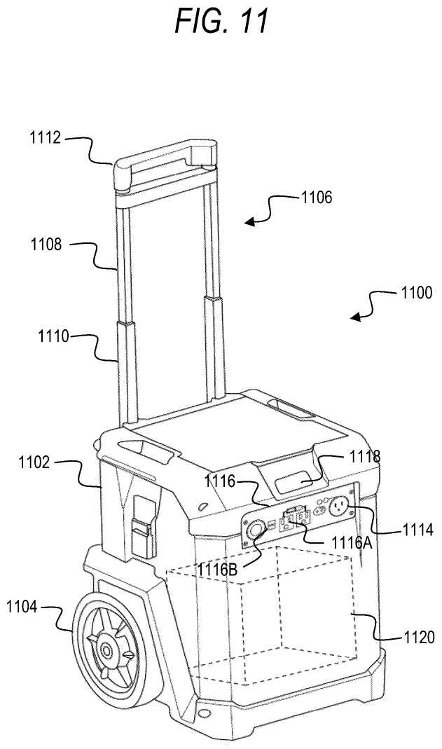

FIG. 11 illustrates a portable power supply device or power supply 1100. The portable power supply device 1100 includes, among other things, a housing 1102. In some embodiments, the housing 1102 includes one or more wheels 1104 and a handle assembly 1106. In the illustrated embodiment, the handle assembly 1106 is a telescoping handle movable between an extended position and a collapsed position. The handle assembly 1106 includes an inner tube 1108 and an outer tube 1110. The inner tube 1108 fits inside the outer tube 1110 and is slidable relative to the outer tube 1110. The inner tube 1108 is coupled to a horizontal holding member 1112. In some embodiments, the handle assembly 1106 further includes a locking mechanism to prevent inner tube 1108 from moving relative to the outer tube 1110 by accident. The locking mechanism may include notches, sliding catch pins, or another suitable locking mechanism to inhibit the inner tube 1108 from sliding relative to the outer tube 1110 when the handle assembly 1106 is in the extended position and/or in the collapsed position. In practice, a user holds the holding member 1112 and pulls upward to extend the handle assembly 1106. The inner tube 1108 slides relative to the outer tube 1110 until the handle assembly 1106 locks in the extended position. The user may then pull and direct the power supply 1100 by the handle assembly 106 to a desired location. The wheels 104 of the power supply 1100 facilitate such movement.

The housing 1102 of power supply 1100 further includes a power input panel 1114, a power output panel 1116, and a display 1118. In the illustrated embodiment, the power input panel 1114 includes multiple electrical connection interfaces configured to receive power from an external power source. In some embodiments, the external power source may be a DC power source, for example, a photovoltaic cell (e.g., a solar panel), or the power source may be an AC power source, for example, a conventional wall outlet. In some embodiments, the power input panel 1114 is replaced by or additionally includes a cable configured to plug into a conventional wall outlet. The power received by power input panel 1114 may be used to charge an internal power source 1120 disposed within the housing 1102 of power supply 1100. In some embodiments, the power supply 1100 includes one or more rechargeable battery cells enclosed within the housing 1002. The battery cells can be arranged in series, parallel, or a series-parallel combination. For example, the power supply 1100 can include a total of 28 battery cells configured in a series arrangement. In some embodiments, the lowest voltage of each of the cells is 2.5V and each battery cell having a nominal voltage of approximately 3.6V-4.2V, such that the power supply 1100 has a nominal voltage of approximately one-hundred and eighteen volts (118V).

The power output panel 1116 includes one more power outlets. In the illustrated embodiment, the power output panel 1116 includes a plurality of AC power outlets 1116A and DC power outlets 1116B. It should be understood that number of power outlets included in power output panel 1116 is not limited to the power outlets illustrated in FIG. 11. For example, in some embodiments of the power supply 1100, the power output panel 1116 may include more or fewer power outlets than the power outlets included in the illustrated embodiment of power supply 1100. The power output panel 1116 is configured to provide power from the internal power source 1120 to one or more peripheral devices. The one or more peripheral devices may be a smartphone, a tablet computer, a laptop computer, a portable music player, a power tool, a power tool battery pack, a power tool battery pack charger, or the like. The peripheral devices may be configured to receive DC and/or AC power from the power output panel 1116. The power supply 1100 could include the circuit 550, 650 within the housing 1002.

The display 1118 is configured to indicate a state of the power supply 1100 to a user, such as state of charge of the internal power source 1120 and/or fault conditions. In some embodiments the display 1118 includes one or more light-emitting diode (“LED”) indicators configured to illuminate and display a current state of charge of internal power source 1120. In some embodiments, the display 1118 is, for example, a liquid crystal display (“LCD”), a light-emitting diode (“LED”) display, an organic LED (“OLED”) display, an electroluminescent display (“ELD”), a surface-conduction electron-emitter display (“SED”), a field emission display (“FED”), a thin-film transistor (“TFT”) LCD, etc. In other embodiments, the power supply 1100 does not include a display.

During charging of the power supply 1100, voltage drop across full bridge rectifier diodes is about 3V, voltage drop across secondary windings of hf transformer is about 2V. Therefore, the secondary voltage needed for charging the power supply 1100 is about 75V ([28 cells×lowest voltage of 2.5V]+3 voltage drop across bridge+2 voltage drop across HF transformer=75V). In some embodiments, the lowest primary voltage needed to maintain PFC converter operation is about 175V. Therefore, the required turns ratio for charging the power supply 1100 using the charging scheme discussed with respect to FIGS. 5 and 6 is 2.5. The turns ratio can be calculated by dividing the lowest primary voltage needed to maintain PFC converter operation of 175V by the secondary voltage needed for charging the power supply 1100 of 75V, which is 2.33, rounded up to 2.5. For a charging output of 75V, with turns ratio of 2.5, the PFC converter output voltage is about 187.5V (2.5×75V=187.5V). At maximum cell voltage of 4.2V, the secondary voltage needed for charging the power supply 1100 is about 122.6V ([28 cells×maximum voltage of 4.2V]+3 voltage drop across bridge+2 voltage drop across hf transformer=122.6V). With turns ratio of 3.5, PFC output voltage will go up to about 306.5V (2.5 turns×secondary voltage needed 122.6V=306.5V).

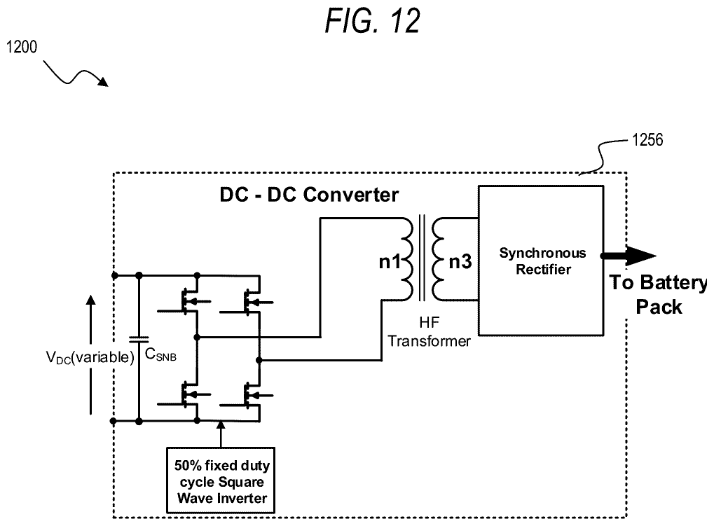

Referring to FIG. 12, in some embodiments, battery packs with only 2.5V per cell may need to be charged. FIG. 12 depicts an example circuit 1200 to accommodate charging batteries with 2.5V per cell, for example, as used in North American markets. The charger 100 can include a DC-to-DC converter 1256 designed to operate similarly to the DC-to-DC converters 456, 556, 656, 756 discussed with respect to FIGS. 4-7. The DC-to-DC converter 1256 can also include a HF transformer designed with a turns ratio (n1:n3) to work with various sized batteries with different cell configurations. A summary of the transformer turn ratios for the example battery packs discussed with respect to FIGS. 8-11 is provided below.

TABLE 1

| Battery Pack | Calculated Turns | Lowest PFC | Highest PFC | Feasibility of |
|---|---|---|---|---|
| Configuration | Ratio (n1:n3) | Voltage Desired | Voltage Desired | PFC Operation |
| 3 cells in series | 17:1 | 178.5 V | 265.2 V | Yes |
| 5 cells in series | 12:1 | 186.0 V | 288.0 V | Yes |
| 20 cells in series | 7:2 | 192.5 V | 311.5 V | Yes |
| 28 cells in series | 5:2 | 187.5 V | 306.5 V | Yes |

TABLE 1 shows a summary of transformer turns ratio for various chargers with the lowest PFC voltage of about 2.5V per cell and highest PFC voltage of about 4.2V per cell. Each of the provided examples would be feasible for PFC operation, as discussed herein. The PFC operation range provided in TABLE 1 shows that the PFC output voltage range is not high and will yield efficient operation of the charger 100. In the provided examples, the lowest voltage to confirm PFC operation is about 170V. The values provided in relation to FIGS. 8-11 and as provided in TABLE 1 are not intended to limit the scope of the present disclosure. Any combination of battery packs with different combination of cells (number and configuration) can be used with different turn ratios without departing form the scope of the present disclosure.

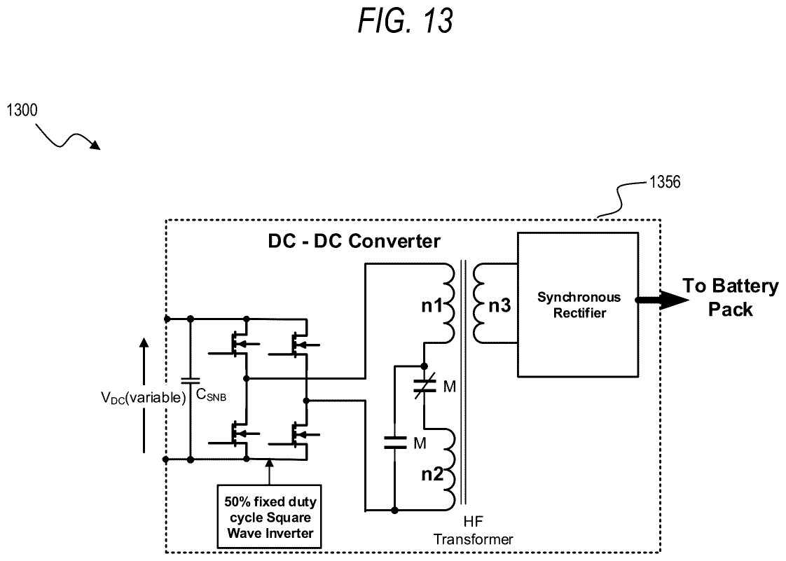

Referring to FIG. 13, in some embodiments, battery packs with only 1V per cell may need to be charged. FIG. 13 depicts an example circuit 1300 to accommodate a low state of charge of a battery pack being charged. The charger 100 can include a DC-to-DC converter 1356. The DC-to-DC converter 1356 can be designed to operate similarly to the DC-to-DC converters 456, 565, 656, 756 discussed with respect to FIGS. 4-7. The DC-to-DC converter 1356 can also include a HF transformer designed with two primary windings having combined a turns ratio (n1+n2:n3) to work with various sized batteries with different cell configurations. In some embodiments, the DC-to-DC converter 1356 can include a contactor arrangement M to control switching between the two primary windings (n1, n2). The contactor arrangement M is made up of a normally closed and a normally open contactor that are provided across one section of the primary winding. The contactor M is turned ON (closed) when the state of charge of the battery pack is greater than 2.5V and n2 is bypassed. This changes the turns ratio to n1:n3. Similarly, the contactor M is OFF (open) when a state of charge of the battery pack is in between 1V per cell and 2.5V per cell and n2 is connected in series to n1.

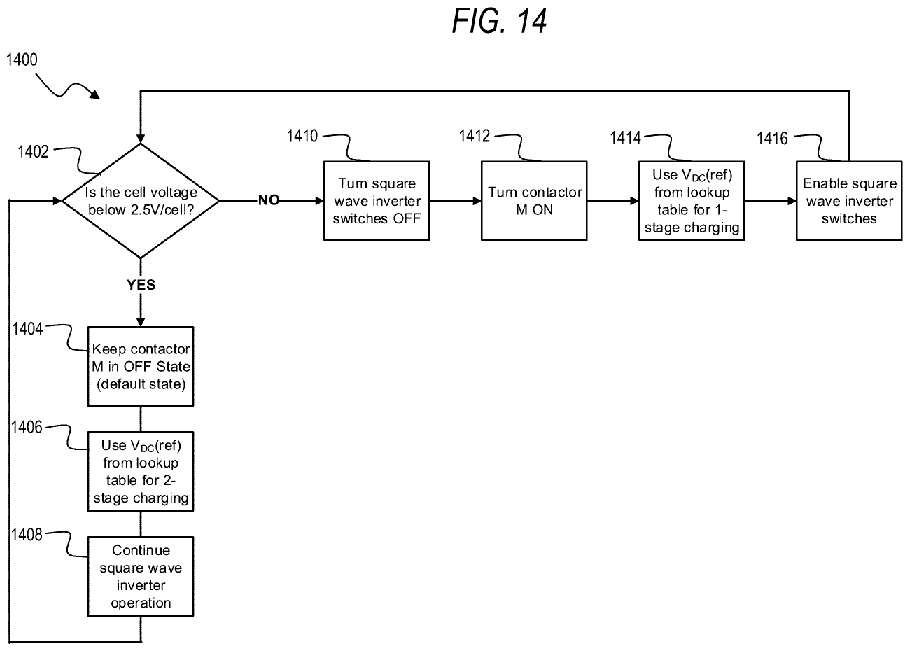

Referring to FIG. 14, a process 1400 is illustrated for managing charging of battery packs with only 1V per cell. To accommodate such a low state of charge for battery cells, and to bring the battery pack from its lowest chargeable voltage of 1V per cell to its standard charge voltage of 2.5V cell, a two-stage charging methodology is used. FIG. 14 depicts a decision loop 1400 of a control strategy to enable two-stage charging to handle extremely low state of charge (SOC) of a battery pack, for example, using a circuit design 1300 as shown in FIG. 13. Since the lowest possible cell voltage of 1V per cell is almost half of 2.5V per cell, in the two-stage charging strategy shown in FIG. 14, the primary winding is made up of two sections of turns, for example, as shown in FIG. 13. By using two sets of primary windings, even a very low cell voltage of 1V per cell can be accommodated. In some embodiments, when the battery voltage is at 1V per cell, both the two primary windings are connected in series. Connecting the windings in series increases the turns ratio to (n1+n2):n3.

Continuing with FIG. 14, at step 1402, the charger 100 determines whether the cell voltage is below 2.5V per cell. For example, a battery voltage feedback loop can be provided, which monitors the cell voltage. If the cell voltage is below 2.5V, the process 1400 will advance to step 1404 and if 2.5V or higher, the process 1400 will advance to step 1410. Since the battery voltage is higher than zero, the output rectifier diodes prevent the battery from discharging into the secondary of the HF transformer. At step 1404, the contactor M will continue to operate in a default OFF state. While the contactor M if OFF, the first section is disconnected, and the second section is connected in its entirety across the inverter switches. At step 1406 a lookup table (e.g., TABLE 2) is referenced to determine a V_{DCRef} value for two-stage charging. At step 1408 the process 1400 will continue the square wave inverter operation and loops back to step 1402 to continue monitoring voltage across the battery pack.

Returning to step 1402, the voltage across the battery pack is continually monitored and when it reaches a 2.5V per cell value or greater, the process 1400 advances to step 1410. At step 1410, the inverter switches connected to the primary of the transformer are turned OFF. At step 1412 the contactor M is turned ON. While the contactor M if ON, the second section n2 is disconnected, and the first section is connected in its entirety. At step 1414 a lookup table (e.g., TABLE 1 or just the top row of TABLE 2) is referenced to determine a V_{DCRef} value for one-stage charging. At step 1416 the process 1400 will continue the square wave inverter operation and loops back to step 1402 to continue monitoring voltage across the battery pack. After the contactor operation is accomplished, the gate signals to the inverter are enabled and normal operation is restored. The switch over can happen under a no load condition. The battery starts getting charged from its present state of 2.5V per cell to 4.2V per cell following the normal one-stage charging process.

The value of the output voltage from the PFC to accommodate low state of charge condition is calculated and summarized in TABLE 2, provided below. Specifically, TABLE 2 provides a summary of transformer turns ratio for different battery packs during two-stage charging, for example, in North American markets.

TABLE 2

| | | Calculated | | | |
|---|---|---|---|---|---|
| | | Turns Ratio | | | |
| | | (n1:n3) | Lowest PFC | Highest PFC | Feasibility |
| Battery Pack | Cell Voltage | (n1 + n2):n3 | Voltage | Voltage | of PFC |
| Configuration | Value | (optional) | Desired | Desired | Operation |
| 3 cells in | 2.5 V to | 17:1 | 178.5 V | 265.2 V | Yes |
| series | 4.2 V/cell | n1:n3 | | | |
| | 1 V/cell to | (17 + 17):1 | 187.0 V | 340.0 V | Yes |
| | 2.5 V/cell | (n1 + n2):n3 | | | |
| 5 cells in | 2.5 V to | 12:1 | 186.0 V | 288.0 V | Yes |
| series | 4.2 V/cell | n1:n3 | | | |
| | 1 V/cell to | (12 + 11):1 | 184.0 V | 356.5 V | Yes |
| | 2.5 V/cell | (n1 + n2):n3 | | | |
| 20 cells in | 2.5 V to | 7:2 | 192.5 V | 311.5 V | Yes |
| series | 4.2 V/cell | n1:n3 | | | |
| | 1 V/cell to | (7 + 8):2 | 174.0 V | 397.5 V | Yes |
| | 2.5 V/cell | (n1 + n2):n3 | | | |
| 28 cells in | 2.5 V to | 5:2 | 187.5 V | 306.5 V | Yes |
| series | 4.2 V/cell | n1:n3 | | | |
| | 1 V/cell to | (5 + 6):2 | 171.0 V | 400 V | Yes |
| | 2.5 V/cell | (n1 + n2):n3 | | | |

As shown in TABLE 2, PFC operation range for various battery packs shows that the transformation ratio increases to accommodate 1V per cell case. The values provided in relation to FIGS. 13 and 14 and as provided in TABLE 2 are not intended to limit the scope of the present disclosure. Any combination of battery packs with different combination of cells (number and configuration) can be used with different turn ratios without departing form the scope of the present disclosure.

In some embodiments, different turns ratios can be used when minimum cell voltage is 2.5V per cell, as summarized in TABLE 3 provided below. Specifically, TABLE 3 provides a summary of transformer turns ratio for different battery packs, for example, in markets outside of North America.

TABLE 3

| | | Lowest PFC | Highest PFC | | |
|---|---|---|---|---|---|
| | | Voltage Desired | Voltage Desired | | |
| Battery Pack | Calculated | (pack at | (pack at | | Feasibility of |
| Configuration | Turns Ratio (n1) | 2.5 V/cell) | 4.2 V/cell) | | PFC Operation |
| 3 cells in series | 33:1 | 346.5 V | 514.8 | V | Yes |
| 5 cells in series | 22:1 | 341.0 V | 528.0 | V | Yes |
| 20 cells in series | 25:4 | 343.75 V | 556.25 | V | Yes |
| 28 cells in series | 23:5 | 345.5 V | 563.96 | V | Yes |

As shown in TABLE 3, the transformation range is not high and will yield efficient operation for PFC operations for various battery packs as shown in TABLE 3. Using the battery pack examples in TABLE 3, the lowest voltage to confirm PFC operation is about 340V. In some embodiments, two capacitors rated at about 400V can be provided in series at the output of the PFC to improve performance. Similarly, high voltage MOSFETs of about 650V-700V can be included to handle the high output voltage. The values provided in TABLE 3 are not intended to limit the scope of the present disclosure. Any combination of battery packs with different combinations of cells (number and configuration) can be used with different turn ratios without departing form the scope of the present disclosure.

Returning to FIG. 13, in some embodiments, the winding changeover process can be used to overcome drawbacks of high PFC output in implementations in markets outside of North America (e.g., rest of world). By using two sets of primary windings, changeover is initiated to keep the output of the PFC (V_{DC(variable)}) within 450V. Battery pack voltage at the changeover of windings is slightly different for each battery pack type and will use a pack specific changeover look-up table, for example, TABLE 4 provided below.

In some embodiments, winding changeover can be implemented using battery pack 800. During charging of the battery pack 800, voltage drop across full bridge rectifier diodes is about 2V, voltage drop across secondary windings of HF transformer is about 1V. Therefore, the secondary voltage needed for charging the battery pack 800 is about 10.5V ([3 cells×lowest voltage of 2.5V]+2 voltage drop across bridge+1 voltage drop across HF transformer=10.5V). In some embodiments, the lowest primary voltage needed to maintain PFC converter operation is about 340V). The turns ratio for implementing a winding change strategy can be calculated by dividing the lowest primary voltage needed to maintain PFC converter operation of 340V by the secondary voltage needed for charging the battery pack 800 of 10.5V, which is 32.38, rounded up to 33. For a charging output of 10.5V, with turns ratio of 33, the PFC converter output voltage is about 346.5V (33×10.5V=346.5V). At maximum cell voltage of 4.2V, the secondary voltage needed for charging the battery pack 800 is about 15.6V ([3 cells×maximum voltage of 4.2V]+2 voltage drop across bridge+1 voltage drop across HF transformer=15.6V). With turns ratio of 33, PFC output voltage will go up to about 514.8V (33 turns×secondary voltage needed 15.6V=514.8V. This voltage is very high, therefore, it is preferred that the voltage at the output of the PFC be limited to 450V so that DC bus capacitors are easily available and are compact in size. To achieve this, the winding changeover technique of FIG. 13 can be used.

In some embodiments, the maximum PFC output voltage is about 435V. For a maximum needed secondary voltage of 15.6V and a maximum PFC output voltage of 435V (450-15V), the turns ratio needed is 28 (maximum output voltage 435V divided by 15.6V is 27.88 rounded up to 28). For the lowest PFC voltage that assures PFC operation is 340V, with a ratio of 28, the lowest reflected secondary voltage will be 12.14V (PFC operation of 340V divided by 28 turns, for 12.14V). Subtracting 3V from this for rectifier and secondary voltage drops is 9.14V, such that the lowest pack voltage that can be supported with this winding is about 3.1V per cell (9.14V divided by 3 cells). Therefore, a switchover voltage of 3.1V is selected and below this voltage, the winding will need to be changed to get the higher ratio. For a cell voltage of 3.1V and a ratio of 28, the output of the PFC desired is 344.4V. This is sufficient to confirm PFC operation. Just before the switchover, at 3.1V/cell and a ratio of 33, the PFC would have reached a voltage of 405.9V, which is below 450V and acceptable.

Based on the calculations for the two turn values, for the battery pack 800, two sectional primary windings are used with a contactor M as shown in FIG. 13. For example, M is off when the battery is in between 2.5V/cell and 3.1V/cell. The primary will have a total of 33 turns made of two sections, a first section with 5 turns (n2 shown in FIG. 13) and a second section with 28 turns (n1 shown in FIG. 13). For the 2.5V to 3.1V/cell range, 33 turns are used and from 3.1V/cell to 4.2V/cell, 28 turns are used. This will allow use of 450V capacitors safely at the output of the PFC to accommodate the complete charging range from 2.5V/cell to 4.2V/cell.

In some embodiments, winding changeover can be implemented using battery pack 900. During charging of the battery pack 900, voltage drop across full bridge rectifier diodes is about 2V, voltage drop across secondary windings of HF transformer is about 1V. Therefore, the secondary voltage needed for charging the battery pack 800 is about 15.5V ([3 cells×lowest voltage of 2.5V]+2 voltage drop across bridge+1 voltage drop across HF transformer=15.5V). In some embodiments, the lowest primary voltage needed to maintain PFC converter operation is about 340V. The turns ratio for implementing a winding change strategy can be calculated by dividing the lowest primary voltage needed to maintain PFC converter operation of 340V by the secondary voltage needed for charging the battery pack 900 of 15.5V, which is 21.93, rounded up to 22. For a charging output of 15.5V, with turns ratio of 22, the PFC converter output voltage is about 341V (22×15.5V=341V). At maximum cell voltage of 4.2V, the secondary voltage needed for charging the battery pack 900 is about 24V ([5 cells×maximum voltage of 4.2V]+2 voltage drop across bridge+1 voltage drop across HF transformer=24V). With turns ratio of 22, PFC output voltage will go up to about 528V (22 turns×secondary voltage needed 24V=528V). This voltage is very high, therefore, it is preferred that the voltage at the output of the PFC be limited to 450V so that DC bus capacitors are easily available and are compact in size. To achieve this, the winding changeover technique of FIG. 13 can be used.

In some embodiments, the maximum PFC output voltage is about 435V. For a maximum needed secondary voltage of 24V and a maximum PFC output voltage of 435V (450-15V), the turns ratio needed is 18 (maximum output voltage 435V divided by 24V is 18.125 rounded down to 18). For the lowest PFC voltage that assures PFC operation, with a ratio of 18, the lowest reflected secondary voltage will be 18.94V (PFC operation of 341V divided by 18 turns, for 18.94V). Subtracting 3V from this for rectifier and secondary voltage drops provides 15.94V, such that the lowest pack voltage that can be supported with this winding is about 3.19V per cell (15.94V divided by 5 cells). Therefore, a switchover voltage of 3.2V is selected and below this voltage, the winding will need to be changed to get the higher ratio. For a cell voltage of 3.2V and a ratio of 18, the desire output of the PFC is 342V. This is sufficient to confirm PFC operation. Just before the switchover, at 3.2V/cell and a ratio of 22, the PFC would have reached a voltage of 418V, which is below 450V and is acceptable.

Based on the calculations for the two turn values, for the battery pack 900, two sectional primary windings are used with a contactor M as shown in FIG. 13. For example, M is off when the battery is in between 2.5V/cell and 3.2V/cell. The primary will have a total of 22 turns made of two sections, a first section with 4 turns (n2 shown in FIG. 13) and a second section with 18 turns (n1 shown in FIG. 13). For the 2.5V to 3.2V/cell range, 22 turns are used and from 3.2V/cell to 4.2V/cell, 18 turns are used. This will allow use of 450V capacitors safely at the output of the PFC to accommodate the complete charging range from 2.5V/cell to 4.2V/cell.

In some embodiments, winding changeover can be implemented using battery pack 1000. During charging of the battery pack 1000, voltage drop across full bridge rectifier diodes is about 3V, voltage drop across secondary windings of HF transformer is about 2V. Therefore, the secondary voltage needed for charging the battery pack 1000 is about 55V ([20 cells×lowest voltage of 2.5V]+3 voltage drop across bridge+2 voltage drop across HF transformer=55V). In some embodiments, the lowest primary voltage needed to maintain PFC converter operation is about 345V. The turns ratio for implementing a winding change strategy can be calculated by dividing the lowest primary voltage needed to maintain PFC converter operation of 340V by the secondary voltage needed for charging the battery pack 1000 of 55V, which is 6.27, rounded down to 6.25. For a charging output of 55V, with turns ratio of 6.25, the PFC converter output voltage is about 343.75V (6.25×55V=343.75V), which is above 341V. At maximum cell voltage of 4.2V, the secondary voltage needed for charging the battery pack 1000 is about 88V ([20 cells×maximum voltage of 4.2V]+3 voltage drop across bridge+2 voltage drop across HF transformer=88V). With turns ratio of 6.25, PFC output voltage will go up to about 550V (6.25 turns×secondary voltage needed 88V=550V). This voltage is very high, therefore, it is preferred that the voltage at the output of the PFC be limited to 450V so that DC bus capacitors are easily available and are compact in size. To achieve this, the winding changeover technique of FIG. 13 can be used.

In some embodiments, the maximum PFC output voltage is about 435V. For a maximum needed secondary voltage of 88V and a maximum PFC output voltage of 435V (450-15V), the turns ratio needed is 5 (maximum output voltage 435V divided by 88V is 4.94 rounded up to 5). For this ratio, at a maximum secondary voltage of 88V, the PFC output is recalculated to be 440V. The PFC capacitors utilized can be rated at about 450V to accommodate this expected voltage. For the lowest PFC voltage that assures PFC operation of 341V, with a ratio of 5, the lowest reflected secondary voltage will be 68.2V (PFC operation of 341V divided by 5 turns, for 68.2V). Subtracting 5V from this for rectifier and secondary voltage drops is 63.2V, such that the lowest pack voltage that can be supported with this winding is about 3.2V (rounded up) per cell (63.27V divided by 20 cells). Therefore, a switchover voltage of 3.2V (or 69V at the secondary) is selected and below this voltage, the winding will need to be changed to get the higher ratio. At this voltage, just before winding changeover, with a default ratio of 6.25, the PFC voltage is expected to be 431.25V which is under the 450V rating of the PFC capacitors.

Based on the calculations for the two turn values, for the battery pack 1000, two sectional primary windings are used with a contactor M as shown in FIG. 13. For example, M is off when the battery is in between 2.5V/cell and 3.2V/cell. The primary will have a total of 6.25 turns made of two sections, a first section with 1.25 turns (n2 shown in FIG. 13) and a second section with 5 turns (n1 shown in FIG. 13). For the 2.5V to 3.2V/cell range, 6.25 turns are used and from 3.2V/cell to 4.2V/cell, 5 turns are used. This will allow use of 450V capacitors safely at the output of the PFC to accommodate the complete charging range from 2.5V/cell to 4.2V/cell.

In some embodiments, winding changeover can be implemented using power supply 1100. During charging of the power supply 1100, voltage drop across full bridge rectifier diodes is about 3V, voltage drop across secondary windings of HF transformer is about 2V. Therefore, the secondary voltage needed for charging the power supply 1100 is about 75V ([28 cells×lowest voltage of 2.5V]+3 voltage drop across bridge+2 voltage drop across HF transformer=75V). In some embodiments, the lowest primary voltage needed to maintain PFC converter operation is about 340V. The turns ratio for implementing a winding change strategy can be calculated by dividing the lowest primary voltage needed to maintain PFC converter operation of 340V by the secondary voltage needed for charging the power supply 1100 of 75V, which is 4.53, rounded up to 4.55.

At a maximum cell voltage of 4.2V, the secondary voltage needed is about 122.6V (28 cells×maximum voltage of 4.2V)+3 voltage drop across bridge+2 voltage drop across HF transformer=122.6V). With turns ratio of 4.55, PFC output voltage will go up to 4.55×122.6=557.83V. This voltage is very high for the output capacitors across the PFC. Hence, winding changeover technique is used here to accommodate the range of chargeable voltage for the power supply 1100.

For a maximum PFC voltage of 435V and a maximum secondary voltage of 122.6V, the ratio needs to be 435/122.6=3.548 or 3.6 (rounded up). For this ratio, at a maximum secondary voltage of 122.6V, the PFC output is recalculated to be 441.36V. The PFC capacitors are assumed to be rated at 450V to accommodate this expected voltage. For the lowest voltage of 341V and the ratio of 3.6, the secondary voltage will be 94.72V. Subtracting 5V, from this for rectifier and secondary voltage drops is 89.72V, such that the lowest pack voltage that can be supported with this winding is about 3.2V per cell (89.72V divided by 28 cells). At the lowest pack voltage of 70V (75V on secondary side), and a minimum PFC voltage of 341V, the turns ratio needs to be 4.54, rounded up to 4.6. At a turns-ratio of 4.6, for the lowest secondary voltage of 75V, the PFC output should be 345V, which is above 341V and this will assure PFC operation.

Based on the calculations for the two turn values, for the power supply 1100, two sectional primary windings are used with a contactor M as shown in FIG. 13. For example, M is off when the battery is in between 2.5V/cell and 3.2V/cell. The primary will have a total of 4.6 turns made of two sections, a first section with 1 turn (n2 shown in FIG. 13) and a second section with 3.6 turns (n1 shown in FIG. 13). For the 2.5V to 3.2V/cell range, 4.6 turns are used and from 3.2V/cell to 4.2V/cell, 3.6 turns are used. This will allow use of 450V capacitors safely at the output of the PFC to accommodate the complete charging range from 2.5V/cell to 4.2V/cell. Changeover voltage is 3.2V per cell or 95V at the secondary. At this voltage, just before winding changeover, with a default ratio of 4.6, the PFC voltage is expected to be 437V which is below the 450V rating of the PFC capacitors.

The value of the output voltage from the PFC to accommodate low state of charge condition is calculated and summarized in TABLE 4, provided below. Specifically, TABLE 4 provides a summary of transformer turns ratio for various battery packs fed from larger power sources, for example, world markets outside of North America.

TABLE 4

| | | Calculated | | | | |
|---|---|---|---|---|---|---|
| | | Turns Ratio | | | | |
| | | (n1:n3) | Lowest PFC | Highest PFC | | Feasibility |
| Battery Pack | Cell Voltage | (n1 + n2):n3 | Voltage | Voltage | | of PFC |
| Configuration | Value | (optional) | Desired | Desired | | Operation |
| 3 cells in | 3.1 V to | 28:1 | 344.4 V | 436.8 | V | Yes |
| series | 4.2 V/cell | n1:n3 | | | | |
| | 2.5 V/cell to | (28 + 5):1 | 346.5 V | 405.9 | V | Yes |
| | 3.1 V/cell | (n1 + n2):n3 | | | | |
| 5 cells in | 3.2 V to | 18:1 | 342.0 V | 432.0 | V | Yes |
| series | 4.2 V/cell | n1:n3 | | | | |
| | 2.5 V/cell to | (18 + 4):1 | 341.0 V | 418.0 | V | Yes |
| | 3.2 V/cell | (n1 + n2):n3 | | | | |
| 20 cells in | 3.2 V to | 20:4 | 345.0 V | 440.0 | V | Yes |
| series | 4.2 V/cell | n1:n3 | | | | |
| | 2.5 V/cell to | (20 + 5):4 | 343.75 V | 431.25 | V | Yes |
| | 3.2 V/cell | (n1 + n2):n3 | | | | |
| 28 cells in | 3.2 V to | 72:20 | 341.0 V | 441.36 | V | Yes |
| series | 4.2 V/cell | n1:n3 | | | | |
| | 2.5 V/cell to | (72 + 20):20 | 345.0 V | 437 | V | Yes |
| | 3.2 V/cell | (n1 + n2):n3 | | | | |

The winding changeover strategy provided herein is designed to overcome the need for two capacitors in series at the output of PFC to accommodate high PFC voltage. Additionally, voltage at an output of PFC is now much lower and safer and it helps reduce conducted and radiated EMI. In some embodiments, if the cell voltage falls to 1V/cell, pulse width modulation can be adopted to work on top of pulse amplitude modulation schemes.

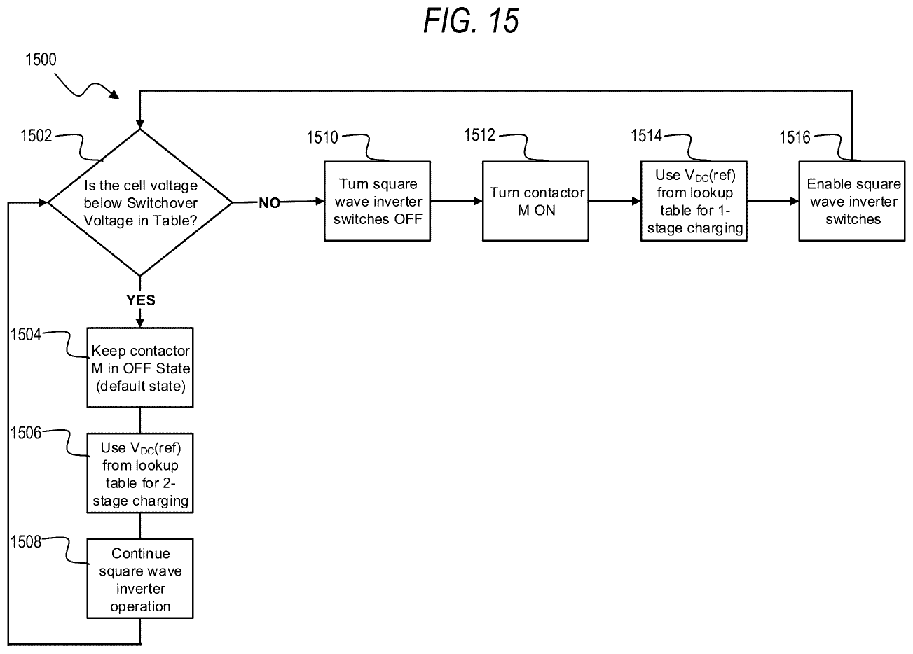

Referring to FIG. 15, in some embodiments, a process 1500 for managing winding changeover to accommodate battery packs powered by different power sources, for example, outside of North America is provided. FIG. 15 depicts a decision loop 1500 of a control strategy to enable winding changeover depending on a type of battery pack, for example, using a circuit design 1300 as shown in FIG. 13. As shown in FIG. 13, the primary winding is made up of two sections of turns with circuitry connecting the windings in series to create the turns ratio (n1:n3, n1+n2:n3).

Continuing with FIG. 15, at step 1502, the charger 100 determines whether the cell voltage is below a predetermined switchover voltage. For example, a battery voltage feedback loops can be provided which monitors the cell voltage and the voltage can be compared to a table with predetermined values to determine if it is below a target value. If the cell voltage is below the predetermined voltage, the process 1500 will advance to step 1504 and if the cell voltage is above the predetermined voltage, the process 1500 will advance to step 1510. Since the battery voltage is higher than zero, the output rectifier diodes prevent the battery from discharging into the secondary of the HF transformer. At step 1504, the contactor M will continue to operate in a default OFF state. While the contactor M is OFF, the first section is disconnected, and the second section is connected in its entirety across the inverter switches. At step 1506 a lookup table is referenced (e.g., TABLE 4) to determine a V_{DCRef} value for two-stage charging. At step 1508 the process 1500 will continue the square wave inverter operation and loops back to step 1502 to continue monitoring voltage across the battery pack.

Returning to step 1502, the voltage across the battery pack is continually monitored and when it reaches predetermined value cell value or greater, the process 1500 advances to step 1510. At step 1510, the inverter switches connected to the primary of the transformer are turned OFF. At step 1512 the contract M is turned ON. While the contactor M if ON, the n2 is disconnected, and n1 is connected. At step 1514, a lookup table is referenced to determine a V_{DCRef} value for one-stage charging. At step 1516, the process 1500 will continue the square wave inverter operation and loops back to step 1502 to continue monitoring voltage across the battery pack. After the contactor operation is accomplished, the gate signals to the inverter are enabled and normal operation is restored. The switch over can happen under no load condition. The battery starts getting charged from its present state of 2.5V per cell to 4.2V per cell following the normal one-stage charging process.

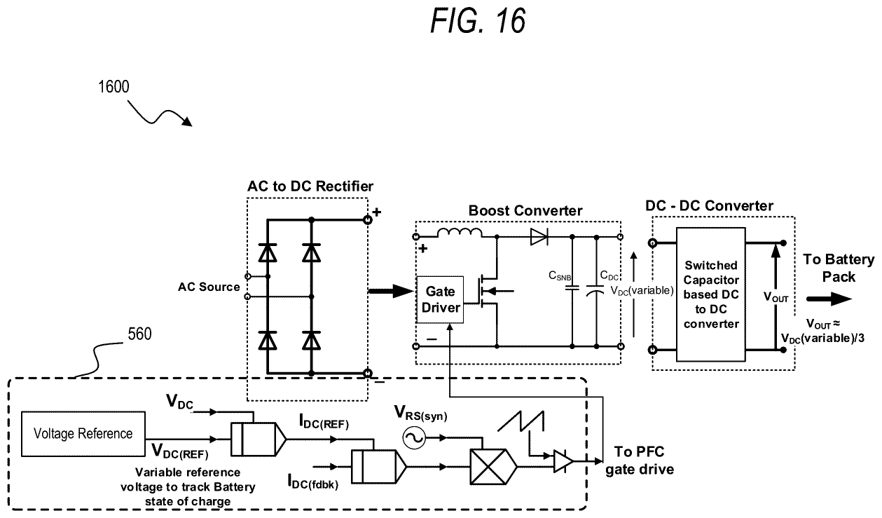

Referring to FIG. 16, in some embodiments, the HF transformer used to achieve an isolated DC-to-DC converter can be removed and/or replaced with a switched capacitor DC-to-DC converter. The switched capacitor DC-to-DC converter can be used in a similar manner as the HF transformer to match the output voltage from the PFC to the needs of the battery pack while maintaining at least the lowest PFC output voltage required to be 170V DC for boost operation with the lowest V_{OUT} being about 50V DC. In another embodiment, a buck converter could be used in place of the HF transformer at the output of a boost PFC. The circuit 1600 can be structured and operate in a similar manner to any of the circuits discussed with respect to FIGS. 3-7, with the exception of the HF transformer being replaced by the switched capacitor-based DC-to-DC converter.

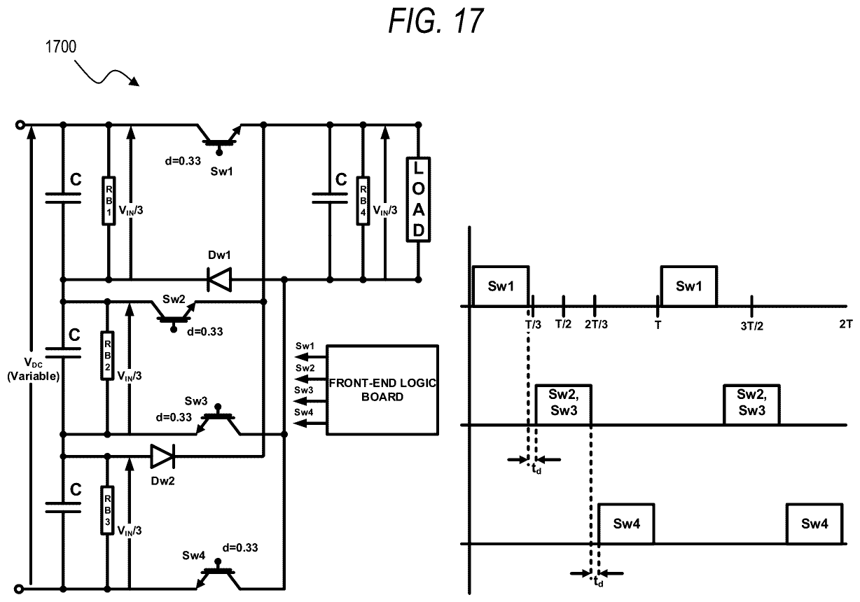

Referring to FIG. 17, an example switched capacitor DC-to-DC converter scheme for use in the circuit 1600 of FIG. 16 is depicted. The switch scheme 1700 provided in FIG. 17 implements insulated-gate bipolar transistors (IGBT), however, other combinations of switches can be used. For example, the IGBTs can be replaced by MOSFETs. In operation, the current through the switches and diodes are about the same as the load current, and the voltage across the switches and diodes are about the same as the output load voltage. The load current in the switching scheme 1700 can be about three times the source current, and the output voltage is about one third of the input voltage. The lowest voltage at the output of the switched capacitor scheme 1700 is expected to be around 53V. Therefore, the switch scheme 1700 is ideal to operate with the battery pack 1000 and power supply 1100 discuss herein. In both cases, the lowest voltage that the cell can go to will be about 2.5V per cell. For a lower desired output voltage, a second stage may need to be employed. However, it will increase the size and cost of the DC-to-DC converter. The output voltage range needed from the PFC to implement the above idea for battery pack 1000 and power supply 1100 is provided in TABLE 5 below.

TABLE 5

| Pack | Cell Voltage | Lowest PFC | Highest PFC | Feasibility of |
|---|---|---|---|---|
| Configuration | Range | Voltage Desired | Voltage Desired | PFC Operation |
| (20 cells in | 2.5 V to | 170.0 V | 267.0 V | Yes |
| series) | 4.2 V/cell | | | |
| (28 cells in | 2.5 V to | 225.0 V | 366.0 V | Yes |
| series) | 4.2 V/cell | | | |

In operation, the battery pack charger 100 can be provided to charge one or more battery packs connected to the battery pack interface(s) 115, 120. Initially, a user can insert at least one battery pack into a battery pack charger, for example, sliding the battery pack(s) into one of the battery pack interface(s) 115, 120. Thereafter, the battery pack charger 100 can charge the at least one battery pack via the battery pack interface(s) 115, 120. For example, the battery pack charger 100 can provide power (e.g., via a power line 340) to the at least one battery pack through the power control module 205 to the battery pack interface(s) 115, 120. In some embodiments, the battery pack charger 100 can communicate with the at least one battery pack (e.g., via communications line 345) to control a rate at which the at least one battery pack receives the power based on a combination of a charging profile and other parameters (e.g., SOC, temperature, cell age, cell health, and charge acceptance based differential voltage). The charging profiles and other parameters can be both monitored data with the battery pack and/or data stored in the memory 305 of the battery pack charger 100.

In some embodiments, the battery pack charger 100 (via controller 200) can be implemented to execute each of the charging methodologies discussed with respect to FIGS. 3-17. The battery pack charger 100 can be configured with any combination of charging circuitry and pre-programmed with one or more of the charging profiles associated with that circuitry. For example, the charger 100 can include the pre-programmed charging profiles stored in memory 305 to be executed by processing unit 300. The battery pack charger 100 can be specifically designed to execute one or more of the charging profiles or it can be designed to change between charging profiles. For example, the battery pack charger 100 can include a selector for choosing which battery profile to execute or it can select a charging profiled based on any combination of battery size, type, environmental conditions, etc.

In some embodiments, multiple simultaneously connected battery packs can be charged using the same charging profile or they can be charged using different charging profiles. For example, a 12V battery pack having a stem can be charged using one charging profile while an 18V battery pack having a plurality of rails can be charged using another charging profile. In some embodiments, the controller 200 can monitor the charging of the connected battery packs, for example, through any combination of the battery pack interface(s) 115, 120, power control module 205, power input circuit 215, thermistor, power input circuit 215, input units 310, output units 315, etc. The controller 200 can process (e.g., processing unit 300) the monitored data and update the charging (e.g., current and/voltage) based on a combination of the charging profiles and the monitored data.

In some embodiments, the charging profiles can include using pulse amplitude modulation of the PFC. By changing the pulse amplitude at the output of the PFC converter, the pulse width, or the pulse frequency on the primary side of the DC-to-DC converter can be maintained at optimal values. This combination will improve the efficiency of power conversion and will also reduce the range of EMI generation. The EMI pattern will be deterministic and more straightforward to mitigate.

In some embodiments, the charging profiles can be designed to operate with battery packs with only 1V per cell. To accommodate such a low state of charge and to bring the pack from its lowest chargeable voltage of 1V per cell to its standard charge voltage of 2.5V per cell, a two-stage charging can be implemented. The two-stage charging includes two primary windings made of a number of turns and when the pack voltage is very low, the additional primary winding is used to increase the turns ratio. When the pack voltage reaches 2.5V per cell, the primary winding is reconfigured to return to the standard turns ratio. Since encountering such low state of charge is unusual, this technique can be offered as an option on the charger 100.

In some embodiments, the two-stage charging described above can be effectively used when the input AC supply to the charger is a high voltage, often encountered in places other than North America. The two-stage charging scheme described above can be extended to rest of the world (ROW) market by altering the turns ratio to accommodate the higher output voltage from the PFC converter. The charger 100 can be designed specifically for one market or for both markets with charging profiles for all voltage variations.

Thus, embodiments described herein provide, among other things, a battery charger with improved charging efficiency, reduced size, and less cost.

1. A battery pack charger for charging a battery pack, the battery pack charger comprising:
one or more battery pack receiving portions configured to receive and interface with the battery pack, the battery pack including one or more battery cells;
a power control module configured to provide power to the one or more battery pack receiving portions using pulse amplitude modulation (PAM); and
a power conversion unit configured to convert the power received from a first external source to a first DC power used for charging the one or more battery cells.

2. The battery pack charger of claim 1, wherein the power conversion unit includes an AC-to-DC rectifier, a power factor correction (PFC) converter, and a DC-to-DC converter.

3. The battery pack charger of claim 2, wherein the PFC converter is a boost converter including a gate driver.

4. The battery pack charger of claim 2, wherein an output of the PFC converter varies based on a state of charge (SOC) of the battery pack.

5. The battery pack charger of claim 2, wherein the DC-to-DC converter includes a high frequency transformer including at least one primary-side winding.

6. The battery pack charger of claim 5, wherein the DC-to-DC converter includes a resonant converter coupled to the high frequency transformer and configured to operate at a fixed frequency.

7. The battery pack charger of claim 5, wherein the DC-to-DC converter includes a full bridge PAM inverter coupled to the high frequency transformer.

8. The battery pack charger of claim 7, wherein the high frequency transformer operates at a duty cycle fixed substantially at or close to 50%.

9-13. (canceled)

14. The battery pack charger of claim 2, wherein the DC-to-DC converter includes a plurality of insulated-gate bipolar transistors (IGBT).

15. The battery pack charger of claim 2, wherein the DC-to-DC converter is a switched capacitor DC-to-DC converter.

16. A method for charging a battery pack, the method comprising:
connecting the battery pack to a battery pack charger;
providing a charging current to one or more battery cells of the battery pack;
providing a fixed square wave inverter signal to a DC-to-DC converter.

17. The method of claim 16, further comprising:
maintaining a contactor in an ON state;
monitoring a cell voltage of the one or more battery cells within the battery pack; and
changing the contactor to an OFF state when the cell voltage of the one or more battery cells is below a threshold value.

18. The method of claim 17, wherein the contactor is configured to increase a turns ratio of a primary-side transformer when in the OFF state.

19. The method of claim 17, further comprising:
determining that the cell voltage of the one or more battery cells is greater than or equal to the threshold value; and
changing the contactor to the ON state.

20. A portable power supply for charging a battery pack, the portable power supply comprising:
a power output panel configured to provide power to the battery pack, the battery pack including one or more battery cells, wherein the power output panel is configured to provide a connection between the portable power supply and the battery pack;
a power control module configured to provide power to the power output panel using pulse amplitude modulation (PAM); and
a power conversion unit configured to convert the power received from a first internal source to a first DC power used for charging the one or more battery cells.

21. The portable power supply of claim 20, wherein the power conversion unit includes an AC-to-DC rectifier, a power factor correction (PFC) converter, and a DC-to-DC converter.

22. The portable power supply of claim 21, wherein the PFC converter is a boost converter including a gate driver.

23. (canceled)

24. The portable power supply of claim 22, wherein the DC-to-DC converter includes a high frequency transformer including at least one primary-side winding.

25. (canceled)

26. The portable power supply of claim 24, wherein the DC-to-DC converter includes a full bridge PAM inverter coupled to the high frequency transformer.

27. The portable power supply of claim 26, wherein the high frequency transformer operates at a duty cycle fixed substantially at or close to 50%.

28-47. (canceled)
